(19) United States
(12) Patent Application Publication
(10) Pub. No.: US 2004/0146769 A1
(43) Pub. Date: Jul. 29, 2004

(54) Fuel cell cartridge for portable electronic device

(76) Inventor: Michael Birschbach, San Francisco, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/726,389

(22) Filed: Dec. 1, 2003

Related U.S. Application Data
(63) Continuation-in-part of application No. 10/309,954, filed on Dec. 3, 2002.
(60) Provisional application No. 60/517,469, filed on Nov. 4, 2003.
(60) Provisional application No. 60/431,139, filed on Dec. 4, 2002.
(60) Provisional application No. 60/430,591, filed on Dec. 2, 2002.

(51) Int. Cl. H01M 8/04

(52) U.S. Cl. 429/34

(57) ABSTRACT

A fuel cell assembly including a membrane electrode assembly, an anode plate, a cathode plate, a removable fuel cartridge, and a fuel delivery system. The assembly includes an anode, a cathode, and a polymer electrolyte membrane having a fuel side and an oxygen side. The fuel cartridge includes an expandable fuel bladder for receiving liquid fuel, an expandable pressure member in contact with the bladder for maintaining a positive pressure on the bladder, and a sealable exit port in fluid communication with the bladder. The fuel delivery system delivers fuel from the cartridge to the fuel side of the membrane. The removable fuel cartridge includes a rigid fuel container having a first container portion and a second container portion permanently enclosing the expandable fuel bladder and the expandable pressure member. The first container portion and the second container portion may be permanently affixed to one another with an adhesive.

### CROSS-REFERENCES TO RELATED APPLICATIONS

This application is a continuation-in-part of U.S. patent application Ser. No. 10/309,954, filed Dec. 3, 2002 entitled FUEL CELL ASSEMBLY FOR PORTABLE ELECTRONIC DEVICE AND INTERFACE, CONTROL, AND REGULATOR CIRCUIT FOR FUEL CELL POWERED ELECTRONIC DEVICE, the entire content of which application is incorporated herein by this reference.

This application also claims priority to U.S. Provisional Patent Application No. 60/517,469 filed Nov. 4, 2003, entitled FUEL CELL ASSEMBLY FOR PORTABLE ELECTRONIC DEVICE, U.S. Provisional Patent Application No. 60/431,139 filed Dec. 4, 2002, entitled IMPROVED FUEL CELL AND FUEL CELL ASSEMBLY FOR PORTABLE ELECTRONIC DEVICE, U.S. Provisional Patent Application No. 60/430,591 filed Dec. 2, 2002, entitled IMPROVED LAPTOP COMPUTER FUEL CELL BASED RECHARGE POWER SUPPLY AND METHOD, the entire content of which applications is incorporated herein by this reference.

### BACKGROUND OF THE INVENTION

1. Field of the Invention

This invention relates to new and improved fuel cell assemblies and cartridges for portable electronic devices. More particularly, the present invention is directed to fuel cartridges used with liquid feed direct methanol polymer electrolyte membrane fuel cell assemblies.

2. Description of Related Art

Polymer electrolyte membranes are useful in electrochemical devices such as batteries and fuel cells because they function as electrolyte and separator. Such membranes may be readily fabricated as thin flexible films which can be incorporated into cells of variable shape.

Perfluorinated hydrocarbon sulfonate ionomers, such as NAFION® by DuPont or analogous Dow perfluorinated polymers, are currently being used as polymer electrolytes for fuel cells. Such prior membranes, however, have some severe limitations for use in both hydrogen/air fuel cells and liquid feed direct methanol fuel cells.

An exemplar of a fuel cell which incorporates such a prior membrane is U.S. Pat. No. 5,759,712 to Hockaday which shows a surface replica fuel cell for a micro fuel cell electrical power pack. The disclosed micro fuel cell electrical power pack is configured to power a cellular phone. An evaporative manifold is provided for wicking out fuel from a fuel tank bottle.

What is needed, among other things, is a fuel cell assembly having a removable fuel cartridge capable of maintaining a positive pressure to facilitate flow of fuel from the cartridge to the fuel cell assembly.

### BRIEF SUMMARY OF THE INVENTION

In one embodiment, a removable fuel cartridge includes a rigid fuel container having a first container portion and a second container portion enclosing the expandable fuel bladder and the expandable pressure member. The first container portion and the second container portion may be permanently affixed to one another. An adhesive may permanently affix the container portions together. In a preferred embodiment, the liquid fuel is methanol.

The second chamber may contain a metering valve in fluid communication with the first chamber by way of a first port and wherein the second chamber includes a second port positioned to be in fluid communication with an anode loop of the fuel cell assembly. The fuel metering valve may be capable of being controlled by an actuator located within the fuel cell assembly. The second chamber may include an inlet and outlet port for fluid communication with the anode loop of the fuel cell assembly, a fluidic connector between the inlet and outlet ports and a metering valve in fluid communication with the first chamber and the fluidic connector. The fuel metering valve may be capable of being controlled by an actuator located within the fuel cell assembly. The fuel cartridge may include a fuel filter in the second chamber in fluid communication with the first chamber or the fluidic connector. The fuel cartridge may include an ion exchange resin in fluid communication with the first chamber or the fluidic connector. The second chamber may include an inlet and outlet port for fluid communication with the anode loop of the fuel cell assembly, a fluidic connector between the inlet and outlet ports and a metering valve in fluid communication with the first chamber and a fuel feed port for fluid communication with the anode loop in the fuel cell assembly.

Another aspect of the present invention is directed to a removable fuel cell cartridge for a liquid fuel cell assembly including a container having a first chamber for fuel having at least one port for delivery of fuel to a fuel cell assembly, and an absorbent device having at least two ports at least one of which communicates with the fuel cell assembly. The absorbent device may be configured to remove water from the exhaust from the fuel cell assembly or carbon dioxide generated on the anode side of the fuel cell. The container may include a second chamber and the absorbent device is located in the second chamber. The first and the second chambers may be separated by an immovable divider. The fuel cartridge may include one or more supplemental components selected from the group consisting of air filters, fuel filters, an ion exchange column, a fan, a pump, a pump control chip, a metering valve, a metering pump, a membrane, a water absorbent, a carbon dioxide absorbent, and a methanol absorbent.

An object of the present invention is to provide a compact fuel cell cartridge for mobile telephones and other portable electronic devices.

Another object of the present invention is to provide a fuel cell cartridge for portable electronic devices which can be quickly refueled thus alleviating the need of lengthy periods of time required to recharge batteries.

Yet another object of the present invention is to provide a fuel cell assembly which can be quickly and conveniently refueled with replaceable fuel cartridges which maintain a positive pressure of fuel.

A further object of the present invention is to provide a removable fuel cartridge which is permanently sealed in order to prohibit inadvertent or intentional tampering with the fuel bladder and/or fuel contained therein.

The accompanying drawings, which are incorporated in and form a part of this specification, illustrate embodiments of the invention and, together with the description, serve to explain the principles of the invention.

### BRIEF DESCRIPTION OF THE DRAWINGS

FIG. 1 is a perspective view schematically showing a fuel cell assembly in combination with a portable electronic device in accordance with the present invention.

FIG. 2 is an exploded front perspective view of the fuel cell assembly shown in FIG. 1 with the portable electronic device removed.

FIG. 3 is an exploded rear perspective view of the fuel cell assembly shown in FIG. 2.

FIG. 4 is a schematic view of a membrane electrode assembly of the fuel cell assembly shown in FIG. 1.

FIG. 5 is an enlarged schematic cross sectional view of the membrane electrode assembly of FIG. 4 shown without electrodes.

FIG. 6 is a perspective view of an anode plate shown in FIGS. 2 and 3.

FIG. 7 is a perspective view of the removable fuel cartridge shown in FIGS. 2 and 3 schematically showing an expandable fuel bladder and an expandable pressure member.

FIG. 8 is an exploded side perspective view of an alternative fuel cell assembly with the portable electronic device removed, similar to that shown in FIG. 1.

FIG. 9(a) is an enlarged plan view of a cathode plate of the fuel cell assembly of FIG. 8.

FIG. 9(b) is an enlarged cross-sectional view of the cathode pate of FIG. 9 taken along line 9-9 in FIG. 9(a).

FIG. 10 is an exploded front perspective view of a removable fuel cartridge of the fuel cell assembly shown in FIG. 8.

FIG. 11 is an exploded front perspective view of a modified removable fuel cartridge, similar to that shown in FIG. 10, for the fuel cell assembly shown in FIG. 8.

FIG. 12(a) is an enlarged, exploded perspective view of a two-way valve assembly for the fuel cell assembly of FIG. 8.

FIG. 12(b) is an enlarged perspective view of the two-way valve assembly of FIG. 12(a).

FIG. 13 is an exploded front perspective view of a modified removable fuel cartridge in accordance with the present invention similar to that shown in FIG. 10.

FIG. 14 is an exploded front perspective view of another modified removable fuel cartridge in accordance with the present invention similar to that shown in FIG. 10.

FIG. 15 is an exploded front perspective view of another modified removable fuel cartridge in accordance with the present invention similar to that shown in FIG. 10.

FIG. 16 is an exploded front perspective view of another modified removable fuel cartridge in accordance with the present invention similar to that shown in FIG. 10.

FIG. 17 is an exploded front perspective view of another modified removable fuel cartridge in accordance with the present invention similar to that shown in FIG. 10.

FIG. 18 is an exploded front perspective view of another modified removable fuel cartridge in accordance with the present invention similar to that shown in FIG. 10.

FIG. 19 is a schematic view of a water recovery system which may be utilized in combination with a fuel cell assembly in accordance with the present invention, for example, with the fuel cell assemblies of FIGS. 1 and 8.

FIG. 20 is a schematic view of a fuel cell assembly flow diagram which may be utilized with a fuel cell assembly in accordance with the present invention, for example, with the fuel cell assemblies of FIGS. 1 and 8.

FIG. 21 is a schematic view of a removable fuel cartridge having a supplemental bladder in accordance with the present invention.

FIG. 22 is a schematic view of a fuel cell assembly adapted for accommodating the freezability of water in accordance with the present invention.

FIG. 23 is a schematic view of a fuel cell assembly adapted to utilize product carbon dioxide in accordance with the present invention.

FIG. 24 is a schematic view of a portion of a fuel cell assembly having a disposable fuel cartridge accordance with the present invention.

FIG. 25 is a schematic view of a portion of a fuel cell assembly having a modified disposable fuel cartridge in accordance with the present invention.

FIG. 26, FIG. 26(a), FIG. 26(b) and FIG. 26(c) are respective schematic views of a refillable injector assembly, a disposable injector assembly, an internal injector assembly and a disposable cartridge injector assembly in accordance with the present invention.

FIG. 27 is a schematic view of a refillable injector assembly in accordance with the present invention.

FIG. 28 is a schematic view of another refillable injector assembly in accordance with the present invention.

FIG. 29 is a schematic view of a disposable injector assembly in accordance with the present invention.

FIG. 30 is a schematic view of another refillable injector assembly in accordance with the present invention.

FIG. 31 is a schematic view of another refillable injector assembly in accordance with the present invention.

FIG. 32 is a schematic view of another refillable injector assembly in accordance with the present invention.

FIG. 33 is a schematic view of another disposable injector assembly in accordance with the present invention.

FIG. 34 is a schematic view of an internal injector assembly in accordance with the present invention.

FIG. 35(a) and FIG. 35(b) are schematic views of an alternative fuel reservoir configuration utilizing a bellows in accordance with the present invention, the bellows being respectively shown empty and full.

FIG. 36(a), FIG. 36(b) and FIG. 36(c) are a schematic views of other fuel reservoir configurations utilizing spring-biased compression plates in accordance with the present invention.

FIG. 37 is a schematic view of an alternative configuration utilizing multiple fuel reservoirs in accordance with the present invention.

FIG. 38 is a schematic view of an alternative replaceable fuel cartridge in accordance with the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

An acidic polymer contains acidic subunits which preferably comprise acidic groups including sulphonic acid, phosphoric acid and carboxylic acid groups. Examples of polymers containing sulfonic acid group include perfluorinated sulfonated hydrocarbons, such as NAFION®; sulfonated aromatic polymers such as sulfonated polyetheretherketone (sPEEK), sulfonated polyetherethersulfone (sPEES), sulfonated polybenzobisbenzazoles, sulfonated polybenzothiazoles, sulfonated polybenzimidazoles, sulfonated polyamides, sulfonated polyetherinides, sulfonated polyphenyleneoxide, sulfonated polyphenylenesulfide, and other sulfonated aromatic polymers. The sulfonated aromatic polymers may be partially or fully fluorinated. Other sulfonated polymers include polyvinysulfonic acid, sulfonated polystyrene, copolymers of acrylonitrile and 2-acrylamido-2-methyl-1 propane sulfonic acid, acrylonitrile and vinylsulfonic cid, acrylonitrile and styrene sulfonic acid, acrylonitrile and methacryloxyethyleneoxypropane sulfonic acid, acrylonitrile and methacryloxyethyleneoxytetrafluoroethylenesulfonic acid, and so on. The polymers may be partially or fully fluorinated. Any class of sulfonated polymer include sulfonated polyphosphazenes, such as poly(sulfophenoxy)phosphazenes or poly(sulfoethoxy)phosphazene. The phosplazene polymers may be partially or fully fluorinated. Sulfonated polyphenylsiloxanes and copolymers, poly(sulfoalkoxy)phosphazenes, poly(sulfotetrafluoroethoxypropoxy) siloxane. In addition, copolymers of any of the polymers can be used. It is preferred that the sPEEK be sulfonated between 60 and 200%, more preferably between 70 to 150% and most preferably between 80 to 120%. In this regard, 100% sulfonated indicates one sulfonic acid group per polymer repeating unit.

Examples of polymers with carboxylic acid groups include polyacrylic acid, polymethacrylic acid, any of their copolymers including copolymers with vinylimidazole or acrylonitrile, and so on. The polymers may be partially or fully fluorinated.

Examples of acidic polymers containing phosphoric acid groups include polyvinylphosphoric acid, polybenzimidazole phosphoric acid and so on. The polymers may be partially or fully fluorinated.

A basic polymer contains basic subunits which preferably comprise basic groups such as aromatic amines, aliphatic amines or heterocyclic nitrogen containing groups. Examples of basic polymers include aromatic polymers such as polybenzimidazole, polyvinylimidazole, N-alkyl or N-arylpolybenzimidazoles, polybenzothiazoles, polybenzoxazoles, polyquinolines, and in general polymers containing functional groups with heteroaromatic nitrogens, such as oxazoles, isooxazoles, carbazole, indoles, isoindole, 1,2,3-oxadiazole, 1,2,3-thiadiazole, 1,2,4-thiadiazole, 1,2,3-triazole, benzotriazole, 1,2,4-traozole, tetrazole, pyrrole, N-alkyl or N-aryl pyrrole, pyrrolidine, N-alkyl and N-arylpyrrolidine, pyridine, pyrazole groups and so on. These polymers may be optionally partially or fully fluorinated. Examples of aliphatic polyamines include polyethyleneimines, polyvinylpyridine, poly(allylamine), and so on. These basic polymers may be optionally partially or fully fluorinated. Polybenzimidazole (PBI) is a preferred basic polymer. Polyvinylimidazole (PVI) is a particularly preferred basic polymer.

An elastomeric polymer comprises elastomeric subunits which preferably contain elastomeric groups such as nitrile, vinylidene fluoride, siloxane and phosphazene groups. Examples of elastomeric polymers include polyacrylonitrile, acrylonitrile copolymers, polyvinyilidene fluoride, vinylidene fluoride copolymers, polysiloxanes, siloxane copolymers and polyphosphazenes, such as poly(trifluormethylethoxy)phosphazene.

The elastomeric polymer may be added to the polymer membrane in the form of polymerizable monomer to fabricate semi-interpenetrating networks. The monomers may be polymerized photochemically or by thermal treatment for the semi-IPN.

An elastomeric copolymer may refer to an elastomeric polymer which contains elastomeric subunits and one or more acidic subunits or basic subunits. For example, if an acidic polymer such as sPEEK is used, an elastomeric copolymer comprising elastomeric subunits and basic subunits may be used in a binary composition. Alternatively, should a basic polymer be used, the elastomeric copolymer will comprise elastomeric subunits and acid subunits. Such binary mixtures may be used in conjunction with other polymers and copolymers to form additional compositions.

One will appreciate that other polymers and copolymers may be utilized such as those disclosed by U.S. patent application Ser. No. 10/438,186 filed May 13, 2003 entitled SULFONATED COPOLYMER and those disclosed by U.S. Pat. No. 10/3438,299 filed May 13, 2003 entitled ION CONDUCTIVE BLOCK COPOLYMERS, the entire content of which patent applications is incorporated herein by this reference.

As used herein, an membrane electrode assembly (MEA) refers to a polymer electrolyte membrane (PEM) in combination with anode and cathode catalysts positioned on opposite sides of the PEM. It may also include anode and cathode electrodes which are in electrical contact with the catalysts layers.

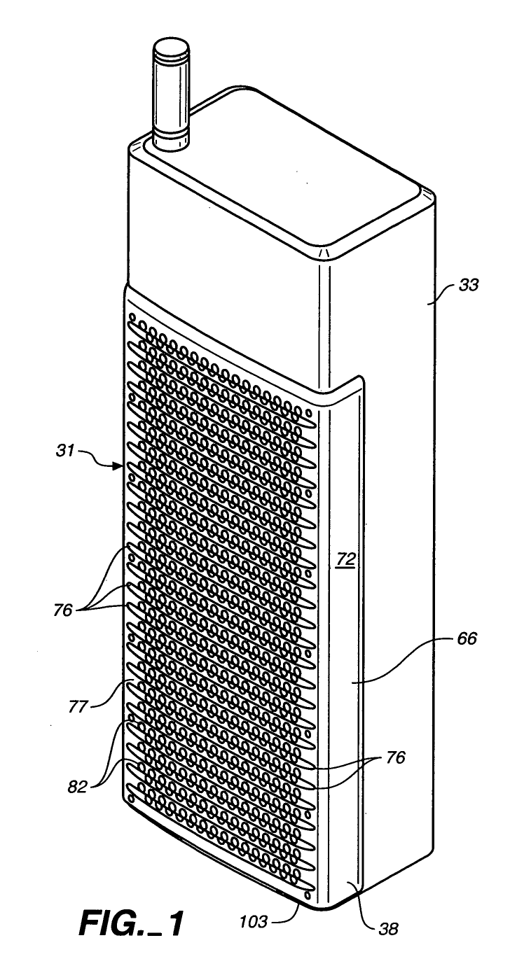

A fuel cell assembly 31 for a portable electronic device 32 in accordance with the present invention is shown in FIG. 1. In the illustrated embodiment, the fuel cell assembly is a liquid fuel cell assembly and the portable electronic device is a mobile telephone. Methanol is a convenient liquid source of fuel which is easy to handle and is readily contained in a simple plastic enclosure. Methanol is also relatively inexpensive and is presently widely available. One should appreciate that other types of fuel can be used.

Fuel cell assembly 31, as illustrated, is adapted for use with a mobile telephone such as a cellular phone. For example, fuel cell assembly 31 can be configured to provide a continuous source of power for a mobile telephone which typically having a power consumption ranging between 360 mA at 3.3 V (1.2 W), when located nearest to a respective transmitter, and 600 mA at 3.3 V (1.98 W) when located furthest from a respective transmitter. One should appreciate, however, that a fuel cell assembly in accordance with the present invention can be configured to provide a continuous source of power for other portable electronic devices having various power consumption ranges and still fall within the scope of the present invention. For example, a fuel cell assembly in accordance with the present invention can be used to power personal digital assistants (PDA's), notebooks and laptop computers, portable compact disc players, and other portable electronic devices.

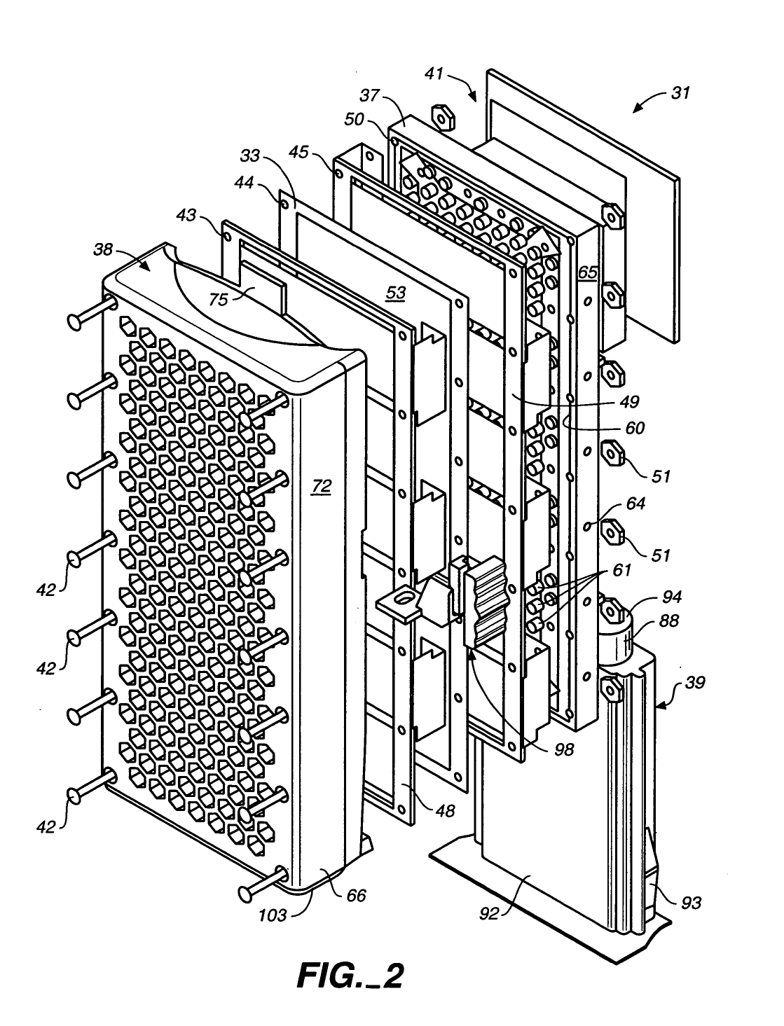

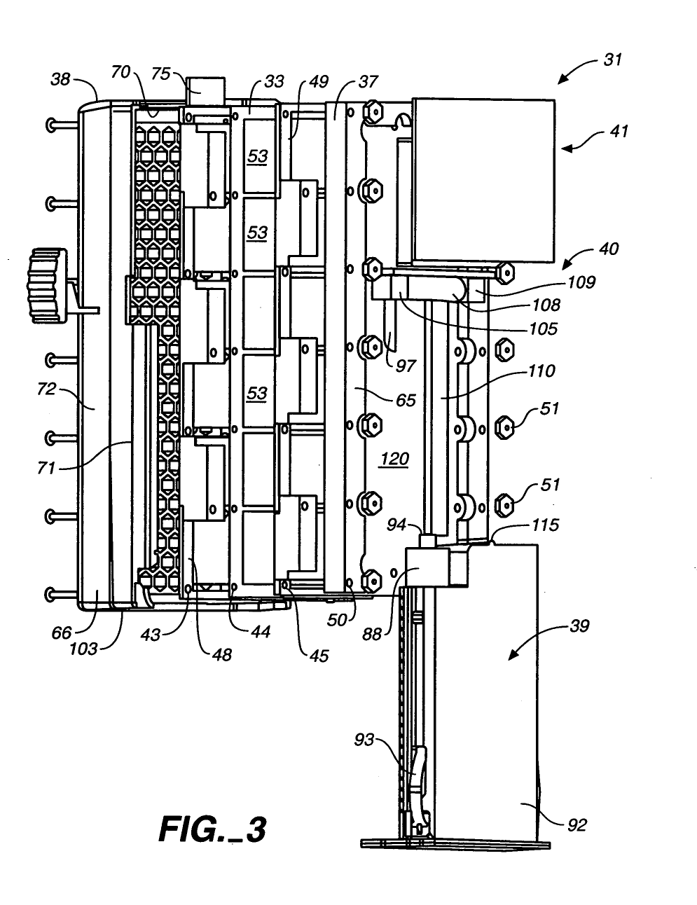

As shown in FIGS. 2 and 3, fuel cell assembly 31 generally includes a membrane electrode assembly 33, an anode plate 37, a cathode plate 38, a removable fuel cartridge 39, a fuel delivery system 40, and a voltage regulator 41. Fuel cell assembly 31 is assembled using various fasteners and/or snap-fit components and/or pressure sensitive adhesives. For example, threaded fasteners 42 extend through cathode plate 38, extend through assembly apertures 43, 44 and 45 located in a cathode electrode 48, membrane electrode assembly 33 and an anode electrode 49, respectively, and extend into assembly apertures 50 located on anode plate 37 and cooperate with nuts 51, as viewed from left to right in FIG. 2. Pressure sensitive adhesives applied to abutting surfaces of the above components can supplement or take the place of the threaded fasteners 42. One should appreciate, however, that other methods of assembly can be used.

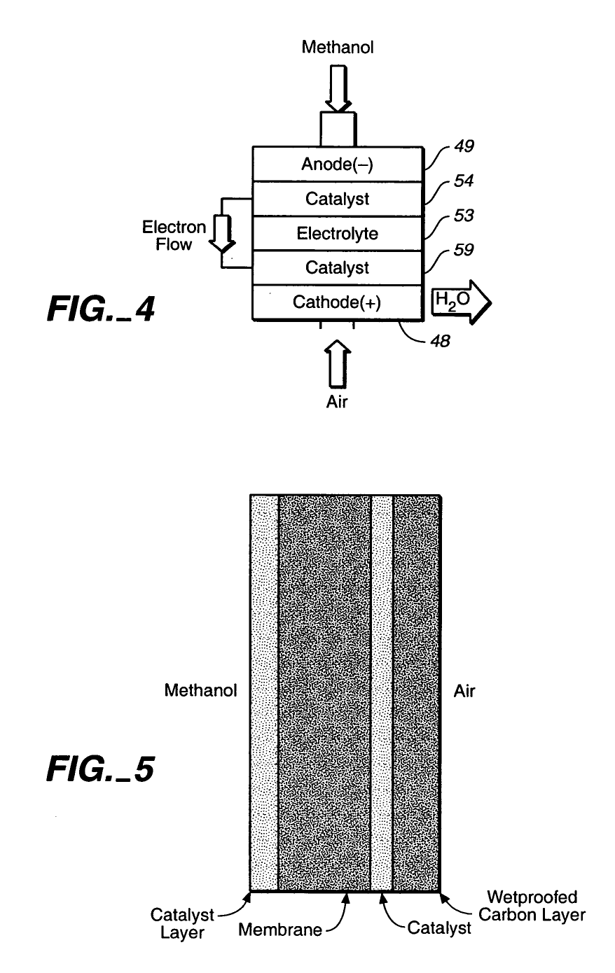

The electrodes are in electrical contact with a polymer electrolyte membrane 53, either directly or indirectly, and are capable of completing an electrical circuit which includes polymer electrolyte membrane 53 and a load of portable electronic device 32 to which a electric current is supplied. More particularly, a first catalyst 54 is electro-catalytically associated with the anode side of polymer electrolyte membrane 53 so as to facilitate the oxidation of an inorganic fuel such as methanol as schematically shown in FIG. 4. Such oxidation generally results in the formation of protons, electrons, carbon dioxide and water. Since polymer electrolyte membrane 53 is substantially impermeable to organic fuels such as methanol, as well as carbon dioxide, such components remain on the anodic side of polymer electrolyte membrane 53. Electrons formed from the electro-catalytic reaction are transmitted from cathode electrode 48 to the load and then to anode electrode 49. Balancing this direct electron current is the transfer of protons or some other appropriate cationic species, i.e., an equivalent number of protons, across the polymer electrolyte membrane to the anodic compartment. There an electro-catalytic reduction of oxygen in the presence of the transmitted protons occurs to form water.

Membrane electrode assembly 33 is generally used to divide fuel cell assembly 31 into anodic and cathodic compartments. In such fuel cell systems, an organic fuel such as methanol is added to the anodic compartment while an oxidant such as oxygen or ambient air is allowed to enter the cathodic compartment. Depending upon the particular use of a fuel cell assembly, a number of individual fuel cells can be combined to achieve appropriate voltage and power output. Such applications include electrical power sources for portable electronic devices such as cell phones and other telecommunication devices, video and audio consumer electronics equipment, computer laptops, computer notebooks, personal digital assistants and other computing devices, geographic positioning systems (GPS's) and the like.

Membrane electrode assembly 33 includes a plurality of membrane electrode assembly cells, each cell generally including one anode electrode 49, one cathode electrode 50, and one polymer electrolyte membrane 53. Each polymer electrolyte membrane is a continuous sheet with catalytic layers. The polymer electrolyte membrane forms an electrolyte between the catalytic layers and is sandwiched together with the catalytic layers between the anode and cathode electrodes. Polymer electrolyte membrane 53 has a fuel side and an oxygen side located adjacent anode electrode 49 and cathode electrode 48, respectively, as schematically shown in FIG. 4. Membrane electrode assembly 33 further includes first catalyst 54 and a second catalyst 59 positioned respectively on the fuel side and the oxygen side of polymer electrolyte membrane 53. The catalyst on the anodic side of the polymer electrolyte membrane is preferably a platinum ruthenium catalyst while the catalyst on the cathode side is preferably a platinum catalyst.

Anode electrode 49 is in electrical communication with first catalyst 54 and cathode electrode 48 is in electrical communication with second catalyst 59. In one embodiment, the electrodes are formed of gold plated stainless steel. The electrodes of each membrane electrode assembly cell are dimensioned and configured to provide electrical contact between the electrode and a respective catalyst layer of the membrane electrode assembly cell. Preferably, each electrode includes a copper tab.

FIG. 5 is a cross section of membrane electrode assembly 33, without electrodes. The membrane electrode assembly includes the polymer electrolyte membrane, the first and second catalyst layers and generally at least one water and gas permeable layer on the cathodic side to provide for the transport of air to and water from the cathode catalyst layer. Generally a carbon paper or carbon cloth is used for such purposes. In addition, a carbon backing is preferably provided on the anode catalyst layer to protect the catalyst layer from damage from the electrodes. Since the backings generally contain conductive material such as carbon, the electrodes can be placed directly on the backing to complete the membrane electrode assembly.

Various membranes can be utilized in accordance with the present invention. For example, a perfluorinated hydrocarbon sulfonate ionomer, such as NAFION® can be used to form the polymer electrolyte membrane in accordance with the present invention. One should appreciate that other membranes can be used.

In one embodiment, a polymer electrolyte membrane includes first, second and optionally third polymers wherein the first polymer is an acidic polymer including acidic subunits, the second polymer is a basic polymer including basic subunits, and wherein (i) the optional third polymer is an elastomeric polymer including elastomeric subunits, or (ii) at least one of the first or second polymers is an elastomeric copolymer further including an elastomeric subunit. Such a polymer electrolyte membrane and a polymer composition therefore are described, as are a membrane electrode assembly, a fuel cell, and an electrochemical device utilizing such a membrane, in copending U.S. patent application Ser. No. 09/872,770, filed Jun. 1, 2001 and entitled POLYMER COMPOSITION, and the corresponding international application, International Publication No. WO 01/94450 A2, published Dec. 13, 2001 and also entitled POLYMER COMPOSITION, in U.S. patent application Ser. No. 10/438,299 filed May 13, 2003 and entitled ION CONDUCTIVE BLOCK COPOLYMERS, U.S. Provisional Patent Application No. 60/449,299 filed Feb. 20, 2003 and entitled IONIC CONDUCTIVE POLYMERS, U.S. patent application Ser. No. 10/438,186 filed May 13, 2003 and entitled SULFONATED COPOLYMER, U.S. patent application Ser. No. 10/351,257 filed Jan. 23, 2003 entitled ACID-BASE PROTON CONDUCTING POLYMER BLEND MEMBRANE, the entire content of which applications are incorporated herein by this reference.

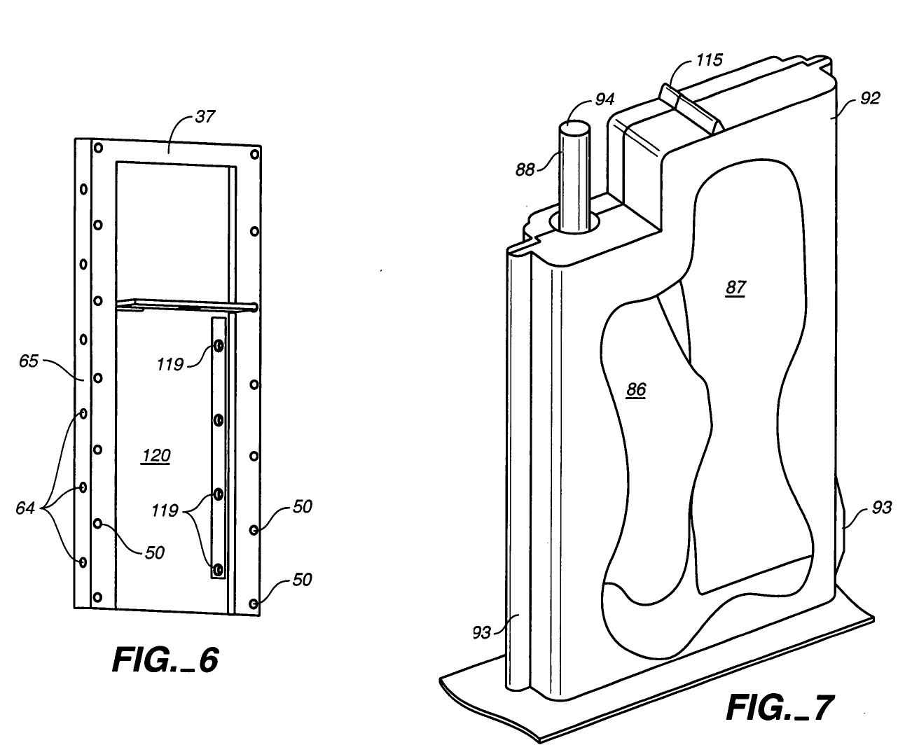

With reference to FIG. 2, anode plate 37 includes an internal recess which forms a fuel chamber 60 fluidly connected to the fuel side of polymer electrolyte membrane 53. Anode plate 37 includes a plurality of posts 61 extending through fuel chamber 60 toward anode electrode 49 for biasing anode electrode 49 into electrical contact with polymer electrolyte membrane 53. Anode plate 37 includes a plurality of exhaust ports 64, shown in FIG. 6. Exhaust ports extend through side walls 65 thus providing an exhaust port which allows carbon dioxide formed within fuel chamber 60 to flow from the fuel chamber.

Cathode plate 38 forms an enclosure or shell 66 having a recess 70 which receives membrane electrode assembly 33, anode plate 37, and removable fuel cartridge 39. Enclosure 66 also includes engagement structure for selectively engaging a mobile telephone or other portable electronic device. The illustrated enclosure includes an engagement track 71 extending along each side wall 72 of the enclosure for slidably engaging portable electronic device 32. Enclosure 66 also includes an engagement tab 75 for selectively latching fuel cell assembly 31 to portable electronic device 32. Contacts for transferring electrical power to the mobile phone are also provided (not shown).

The enclosure is injection molded, however, one should appreciate that other methods of forming the enclosure can be utilized. For example, the enclosure can be machined and the like.

In the embodiment shown in FIG. 1, enclosure 66 includes a plurality of air grooves 76 engineered into an outer surface 77 of enclosure 66 which would normally be in contact with the hand of a mobile telephone user. Intake ports 82 are located in one or more grooves 76 for supplying oxygen to the cathodic chamber. In particular, oxygen intake ports 82 extend from a base of one or more grooves 76 to the oxygen side of polymer electrolyte membrane 53. Such a configuration minimizes the impedance of gas flow through the exhaust ports and the intake ports by the palm of a user's hand.

Removable fuel cartridge 39 generally includes an expandable fuel bladder 86, an expandable pressure member 87, and a sealable exit port 88, as shown schematically in FIG. 7. Removable fuel cartridge 39 includes a rigid container 92 enclosing expandable fuel bladder 86 and expandable pressure member 87. In one embodiment, rigid container 92 is formed in two portions 95, 96 which are permanently affixed to one another such that fuel cartridge may not be readily disassembled. One should appreciate that rigid container may be formed of one, two, three or more discrete components provided that the components provide a rigid housing for supporting and enclosing the fuel bladder. Accordingly, for the purpose of the present invention, the term “portions” refer to the structural components which form the rigid container of the removable fuel cartridge. Although portions 95 and 96 are substantially symmetrical, one will appreciate that the container portions may be asymmetric. For example, one rigid container portion may be formed in the shape of a bottomless canister which is sealed by another rigid portion having a corresponding bottom shape.

Container portions 95, 96 may be formed of an injection molded plastic material in a well known manner. One should appreciate that other suitable materials and suitable methods of manufacture may also be used in accordance with the present invention. For example, the container portions may be formed of plastic, metal, composite and/or other suitable materials. The container portions may be produced by casting, machining, molding, stamping and/or other suitable means of fabrication.

In the illustrated embodiment, container portions 95, 96 are permanently affixed to one another using an adhesive. One will appreciate that other suitable means may also be used in accordance with the present invention including, but not limited to sonic welding, heat welding, solvent bonding and/or permanent adhesives. The permanently affixed configuration of container portions 95, 96 promotes the overall safety of fuel cartridge 39, as well as the safety of fuel cell assembly 31 and portable electronic device 33, because it prohibits inadvertent or intentional tampering with or otherwise misuse the fuel bladder 86 and/or the fuel contained therein.

The fuel cartridge is dimensioned and configured such that the fuel bladder is capable of holding at least approximately 5 cubic centimeters of methanol, preferably at least approximately 7 cubic centimeters of methanol, and most preferably at least approximately 10 cubic centimeters. In the illustrated embodiment, a pair of spring clips 93 is provided to engage container 92 with enclosure 66 and hold the container in place until a user removes container 92 from the enclosure to refuel fuel cell assembly 31.

Expandable fuel bladder 86 receives liquid fuel which is to be supplied to membrane electrode assembly 33. Expandable fuel bladder 86 is formed of a sheet plastic material and/or other polymeric materials which are substantially impervious to methanol. Examples of suitable sheet plastic material include nylon, urethane and polyethylene, silicon rubber, however, one should appreciate that other materials can be used.

Expandable pressure member 87 contacts fuel bladder 86 in such a manner that a positive pressure is maintained on and within the bladder thereby pressurizing the bladder. Sealable exit port 88 fluidly communicates with fuel bladder 86. In the illustrated embodiment, expandable pressure member 87 is a compressed foam member, preferably formed of open cell foam. The compressed foam member is elastic and acts a spring member biased against fuel bladder 86 thus maintaining a positive pressure on the bladder. Other pressure members can be utilized in accordance with the present invention. For example, a spring-biased member can exert a force against fuel bladder 86 in order to maintain a positive pressure on the bladder.

In the illustrated embodiment, sealable exit port 88 of the replaceable fuel cartridge 39 includes a septum 94, as shown in FIG. 7. Septum 94 includes a substantially self-sealing membrane. Referring to FIG. 3, fuel delivery system 40 includes a needle 97 which extends into exit port 88, and through septum 94 for fluidly connecting fuel bladder 86 to the fuel side of polymer electrolyte membrane 53. Sealable exit port 88 is dimensioned and configured to cooperate with needle 97 In one embodiment, the sealable exit port includes an INTERLINK® fluid connection adaptor which is manufactured by Baxter International Inc. of Deerfield, Ill. In particular, fuel delivery system 40 includes needle 97 which is insertable into septum 94. One should appreciate that other types of fluid connectors can be utilized in accordance with the present invention.

Enclosure 66 is also provided with a release latch 98 for disengaging removable fuel cartridge 39 from fuel delivery system 40. Release latch 98 is slidably disposed on one side of enclosure 66 and engages septum 94 of removable fuel cartridge 39. Sliding release latch 98 downward, as viewed in FIG. 2, will push against exit port 88 and thus push removable fuel cartridge 39 at least partially outward past a bottom wall 103 of enclosure 66 and thus at least partially disengage removable fuel cartridge 39 from fuel delivery system 40.

Fuel delivery system 40 fluidly connects fuel bladder 86 of replaceable fuel cartridge 39 to fuel chamber 60 of anode plate 37. Fuel delivery system 40 includes needle 97, a needle block 105, a one-way duck-bill valve 108, a manifold block 109, and a manifold 110 connected in series to interconnect fuel bladder 86 and fuel chamber 60. Needle block 105 supports needle 97 and positions the needle for piercing exit port 88 of removable fuel cartridge 39 as the fuel cartridge is inserted into fuel cell assembly 31. Needle block 105 fluidly interconnects needle 97 and one-way duck-bill valve 108. Preferably needle block 105 includes a barb fitting for engaging one end of duck-bill valve 108.

One-way duck-bill valve 108 is provided for preventing fuel from flowing through fluid delivery system 40 away from fuel chamber 60 and the fuel side of polymer electrolyte membrane 53. One-way duck-bill valve 108 is engagable with a protrusion 115 on container 92 of removable fuel cartridge 39 such that valve 108 is closed when fuel cartridge 39 is removed from fuel cell assembly 31 and such that valve 108 is opened when the fuel cartridge is inserted into the fuel cell assembly. One should appreciate that other one-way valves can be utilized in accordance with the present invention including, but not limited to, Schrader-type valves, needle valves and sports-ball valves. When fuel cartridge 39 is inserted into fuel cell assembly 31, one-way valve 108 remains open allowing fuel to flow from the cartridge to fuel chamber 60 thus allowing mass transport to occur within the fuel chamber. Fuel flow from fuel cartridge 39 toward fuel chamber 60 is facilitated by the positive pressure maintained on the fuel bladder 86.

Manifold block 109 fluidly interconnects one-way duck-bill valve 108 and manifold 110. Preferably manifold block 109 includes a barb fitting for engaging the other end of duck-bill valve 108. Manifold 110 fluidly communicates with a plurality of fuel intake ports 119 located in and extending through a base wall 120 of anode plate 37 as illustrated in FIG. 6. Although fuel intake ports 119 are shown to extend through base wall 120 of anode plate 37, one should appreciate that fuel intake ports can be provided elsewhere on the anode plate.

Voltage and current regulator 41, shown in FIGS. 1 and 2, includes a circuit and a storage battery for monitoring and/or regulating voltage and/or power supplied to portable electronic device 33. Regulator 41 is described in copending U.S. Provisional Application for Patent No. 60/295,475, filed Jun. 1, 2001, entitled INTERFACE, CONTROL, AND REGULATOR CIRCUIT FOR FUEL CELL POWERED ELECTRONIC DEVICE, filed Jun. 1, 2001.

In operation and use, a user will insert a removable fuel cartridge 39 into fuel cell assembly 31 such that needle 87 pierces septum 94 thus allowing fuel to flow from fuel bladder 86 to polymer electrolyte membrane 53 of membrane electrode assembly 33. Once fuel is substantially depleted from fuel cartridge 39, the user slides release latch 98 downward and disengages the fuel cartridge from fuel cell assembly 31. The user then replaces the depleted fuel cartridge with a fresh, that is, a fuel cartridge fully charged with fuel and inserts the fresh cartridge in the same manner described above.

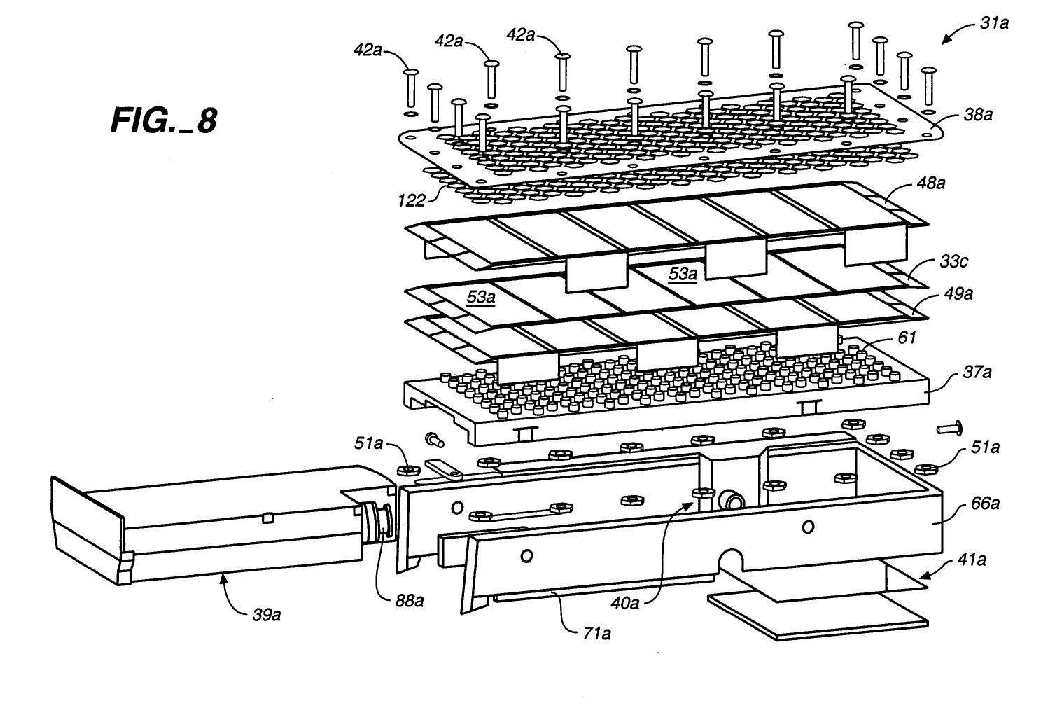

In another embodiment of the present invention shown in FIG. 8, fuel cell assembly 31a is similar to fuel cell assembly 31 described above but includes several modifications as discussed below. Like reference numerals have been used to describe like components of fuel cell assembly 31 and fuel cell assembly 31a.

As shown in FIG. 8, fuel cell assembly 31a generally includes a membrane electrode assembly 33a, an anode plate 37a, a cathode plate 38a, a removable fuel cartridge 39a, a fuel delivery system 40a and a voltage regulator 41a. Fuel cell assembly 31a is assembled using threaded fasteners 42a which extend through cathode plate 38a, cathode electrode 48a, membrane electrode assembly 33a, anode electrode 49a, and anode plate 37a and cooperate with nuts 51a, in the same manner as discussed above with reference to the embodiment shown in FIG. 2.

The electrodes are in electrical contact with a polymer electrolyte membrane 53a, either directly or indirectly, and are capable of completing an electrical circuit which includes polymer electrolyte membrane 53a and a load of the portable electronic device to which a electric current is supplied in the same manner as discussed above. Membrane electrode assembly 33a is generally used to divide fuel cell assembly 31a into anodic and cathodic compartments.

In this embodiment, cathode plate 38a is formed of anodized aluminum. One should appreciate, however, that other materials can also be used in accordance with the present invention. For example, the cathode plate can be formed of polycarbonate or other suitable materials. As aluminum is an electrical conductor, cathode plate 38a is anodized to provide a layer of electrical insulation. One should appreciate that other forms of insulation may be used instead of, or in addition to, anodizing the cathode plate.

Preferably, an insulation layer 122 is also provided between cathode plate 38a and cathode electrode 48a in order to further protect the aluminum cathode plate from shorting individual cells within the fuel cell assembly which would reduce performance significantly. For example, in the event that the anodizing of the cathode plate is scratched the insulation layer would protect the cathode pate from shorting one or more cells. In the illustrated embodiment, insulation layer 122 is formed of vinyl, however, one should appreciate that other electrically insulating materials can be used in accordance with the present invention.

With reference to FIG. 8, anode plate 37a includes an internal recess which forms a fuel chamber fluidly connected to the fuel side of polymer electrolyte membrane 53a. Anode plate 37a includes a plurality of posts 61a extending through the fuel chamber toward anode electrode 49a, in the same manner as anode plate 37 described above, for biasing anode electrode 49a into electrical contact with polymer electrolyte membrane 53a.

Cathode plate 38a in combination with enclosure or shell 66a defines a recess which receives membrane electrode assembly 33a, anode plate 37a, and removable fuel cartridge 39a. Enclosure 66a also includes engagement structure for selectively engaging a mobile telephone or other portable electronic device. Preferably, the enclosure is formed of anodized aluminum or other suitable material similar to that of the cathode plate. The illustrated enclosure includes an engagement track 71a extending along each side wall of the enclosure 66a for slidably engaging a portable electronic device.

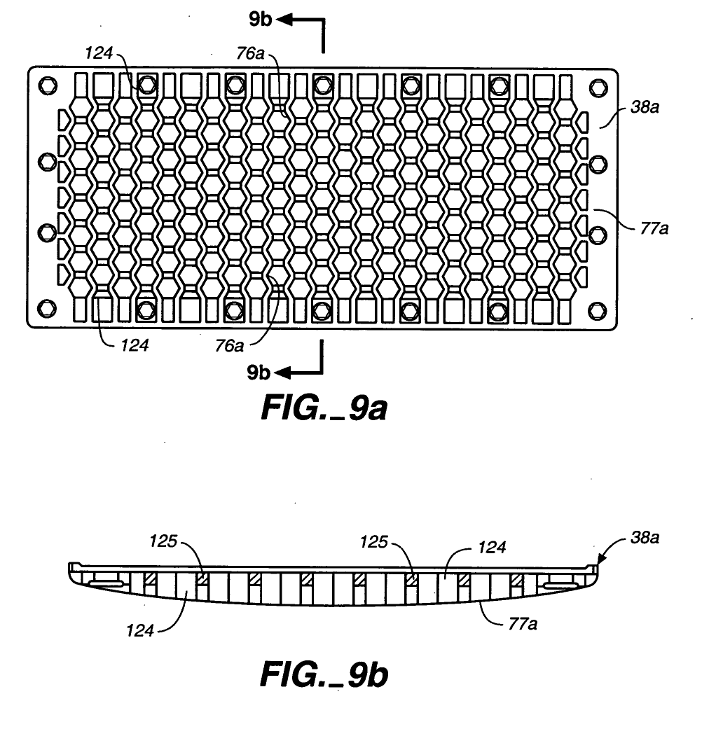

As shown in FIG. 9(b), cathode plate 38a has a convex shape and plurality of laterally extending air grooves 76a engineered into the outer convex surface 77a of cathode plate 38a. In the event that fuel cell assembly 31a is used in combination with a mobile telephone, outer surface 77a would normally be in contact with the hand of a mobile telephone user during use. Air grooves 76a are formed between a plurality of wide or tall laterally-extending webs 124. Intake ports 82a are located in one or more grooves 76a for supplying oxygen to the cathodic chamber. Tall webs 124 intersect with a plurality of narrow or short longitudinally-extending webs 125 thereby forming the oxygen intake ports 82a. Intake ports 82a extend to the oxygen side of polymer electrolyte membrane 53a. Such a configuration minimizes the impedance of gas flow through the exhaust ports and the intake ports by the palm of a user's hand.

The curved configuration of cathode plate 38a further allows side-venting when cathode plate 38a, and any portable electronic device connected thereto such as a mobile telephone, even when the assembly is placed on a flat surface such as a table or a seat. In the embodiment illustrated in FIG. 9(b), cathode plate 38a has a convex profile, however, one should appreciate that a convex profile and other curved profiles can also be used in accordance with the present invention.

Removable fuel cartridge 39a generally includes an expandable fuel bladder 86a, a pair of expandable pressure members 87a, and a sealable exit port 88a, as shown in FIG. 10. Removable fuel cartridge 39a includes a rigid container 92a formed of anodized aluminum or other suitable material including, but not limited to ABS (acrylonitrile butadiene styrene), polycarbonate, polyurethane or stamped sheet metal. Container 92a encloses expandable fuel bladder 86a and the expandable pressure members 87a.

Expandable fuel bladder 86a receives and stores liquid fuel which is to be supplied to membrane electrode assembly 33a. Expandable fuel bladder 86a is plastic material which is substantially impervious to methanol and is vacuum-formed to conform to the interior shape of container 92a. The vacuumed-formed configuration of fuel bladder 86a significantly increases fluid storage within container 92a. Sealable exit port 88a fluidly communicates with fuel bladder 86a.

Expandable pressure members 87a contact fuel bladder 86a in such a manner that a positive pressure is maintained on and within the bladder. In the illustrated embodiment, each expandable pressure member 87a is a compliant foam member having good volume efficiency, including, but not limited to, the type used in acoustical barriers and sold by E-A-R Specialty Composites of Indianapolis, Ind. The compressed foam members are elastic and act as spring members biased against fuel bladder 86a thus maintaining a positive pressure on the bladder. Preferably the pressure members are cut from sheet material in the shape of the interior of cartridge 39a. One should appreciate that other pressure members and devices can be utilized in accordance with the present invention to supply a positive pressure within the fuel bladder.

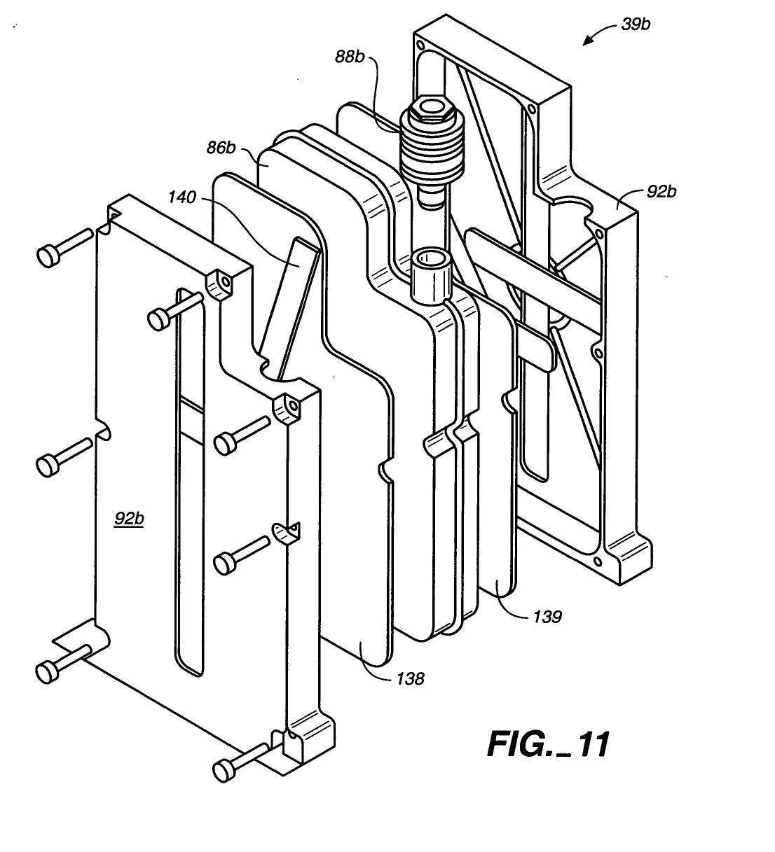

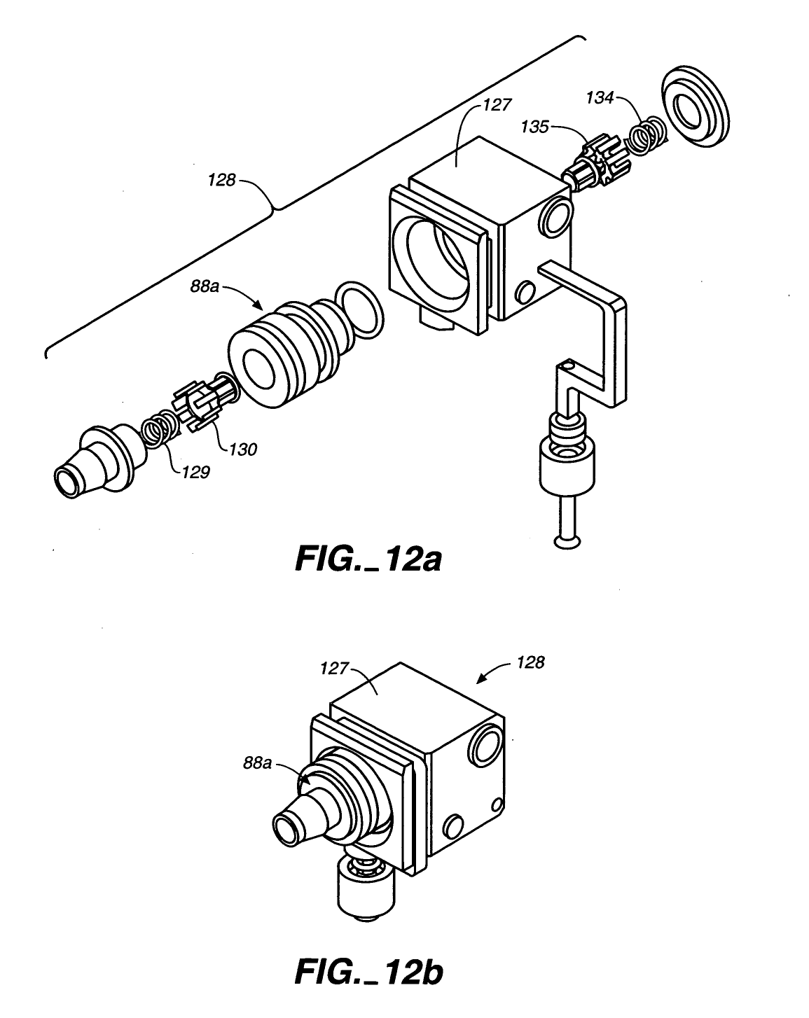

In the embodiment shown in FIG. 8, replaceable fuel cartridge 39a includes a cartridge port or exit port 88a which cooperates with a device port 127 to form a two-way valve shut-off valve 128, as shown in FIGS. 12(a) and 12(b). Two-way valve 128 is a spring-loaded device in which exit port 88a and includes a spring 129 that biases a valve member 130 toward a sealed position such that cartridge 39a is fluidly sealed when the cartridge is removed from the fuel cell assembly 31a but is open when the cartridge is inserted into the fuel cell assembly. Similarly, device port 127 of valve 128 includes a spring 134 that biases a valve member 135 toward a sealed position such that the fuel delivery system 40a of fuel cell assembly 31a is sealed when cartridge 39a is removed from the fuel cell assembly 31a but is open when the cartridge is inserted into the fuel cell assembly. One should appreciate that port 88a is equally suitable for use with the replaceable fuel cartridges described above and below, as well as other fuel cartridge configurations in accordance with the present invention. One should also appreciate that other types of fluid connectors can be utilized in accordance with the present invention.

When cartridge 39a is inserted in fuel cell assembly 31a and exit port 88a is engaged with device port 127, fuel bladder 86a is fluidly connected to the fuel chamber of anode plate 37a via fuel delivery system 40a in a manner similar to that described above with respect to fuel delivery system 40. Fuel flow from fuel cartridge 39a toward the fuel chamber anode plate 37a is facilitated by the positive pressure maintained on the fuel bladder 86a. In operation and use, fuel cell assembly 31a is used in substantially the same manner as fuel cell assembly 31 discussed above.

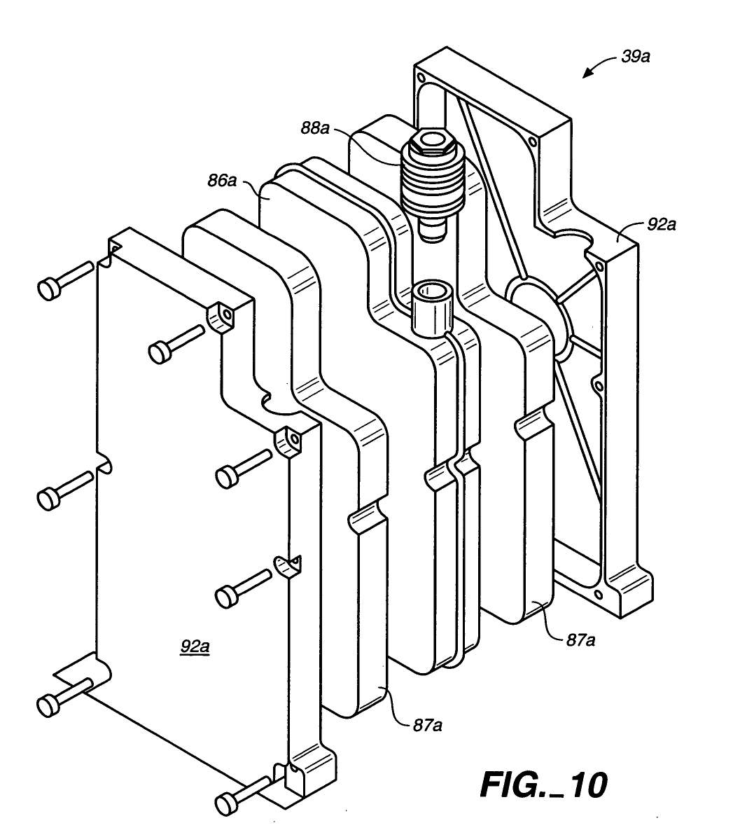

In another embodiment of the present invention, as shown in FIG. 11, a spring-loaded replaceable cartridge 39b includes an alternative configuration for maintaining a positive pressure on fuel bladder 86b. In particular, cartridge 39b includes a pair of compression plates 138, 139 which are biased toward one another and against fuel bladder 86b by a pair of leaf springs 140, 141. One should appreciate that other mechanical pressure members can be utilized to provide a positive pressure on and within the fuel bladder in accordance with the present invention.

In another embodiment of the present invention shown in FIG. 13, removable fuel cartridge 39c is similar to removable fuel cartridge 39a described above but includes several modifications as discussed below. Like reference numerals have been used to describe like components of removable fuel cartridge 39c and the above removable fuel cartridges 39, 39a and 39b.

As shown in FIG. 13, removable fuel cartridge 39c generally includes an expandable fuel bladder 86c, a pair of expandable pressure members 87c, and a sealable exit port 88c. Removable fuel cartridge 39c includes a rigid container 92c formed of polycarbonate or other suitable material. Container 92c includes two container portions 95c and 96c which are permanently adhered or otherwise assembled such that the container permanently encloses expandable fuel bladder 86c and the expandable pressure members 87c. The permanently affixed configuration of container portions 95c and 96c promotes the overall safety of fuel cartridge 39c, as well as the safety of the fuel cell assembly and the portable electronic device with which it is used, because the configuration prohibits inadvertent or intentional tampering with and/or other misuse of the fuel bladder 86c and the fuel contained therein.

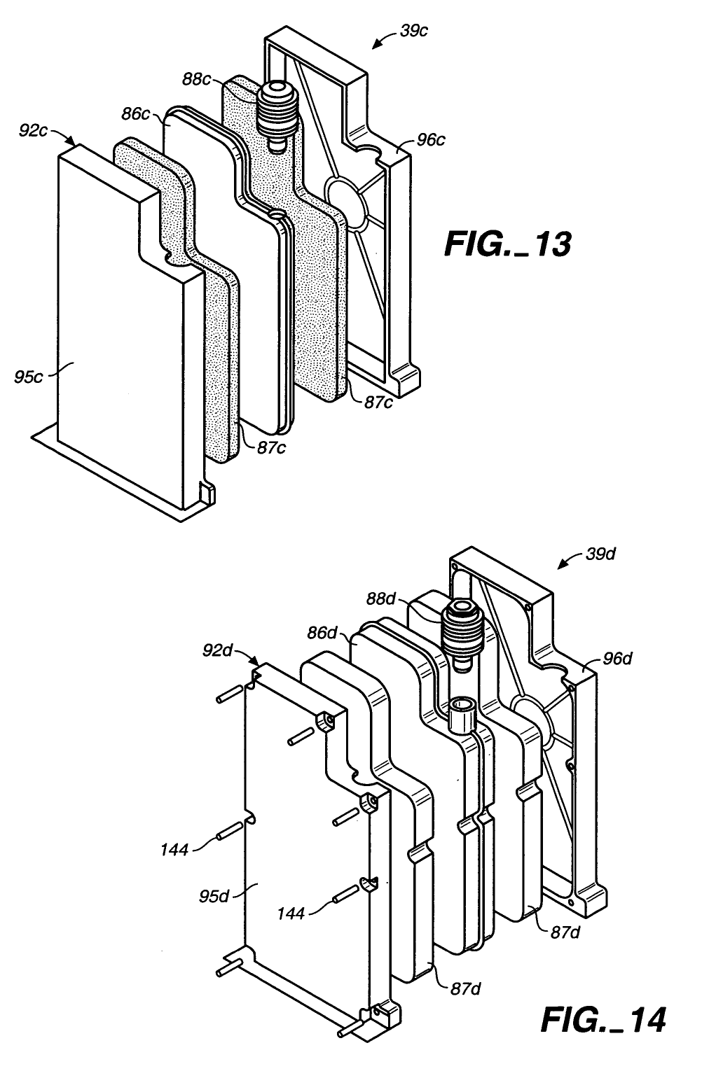

In yet another embodiment of the present invention shown in FIG. 14, removable fuel cartridge 39d is similar to removable fuel cartridges 39a and 39c described above but includes several modifications as discussed below. Like reference numerals have been used to describe like components of removable fuel cartridge 39d and removable fuel cartridges 39, 39a, 39b and 39c.

As shown in FIG. 14, removable fuel cartridge 39d generally includes an expandable fuel bladder 86d, a pair of expandable pressure members 87d, and a sealable exit port 88d. Removable fuel cartridge 39d includes a rigid container 92d formed of anodized aluminum or other suitable material including, but not limited to polycarbonate or stamped sheet metal. Container 92d includes two container portions 95d and 96d which are permanently affixed to one another by rivets 144 or other suitable permanent fasteners such that the container permanently encloses expandable fuel bladder 86d and expandable pressure members 87d. The permanently affixed configuration of container portions 95d and 96d promotes the overall safety of fuel cartridge 39d, as well as the safety of the fuel cell assembly and the portable electronic device with which it is used, because the configuration prohibits inadvertent or intentional tampering with the fuel bladder 86d and the fuel contained therein.

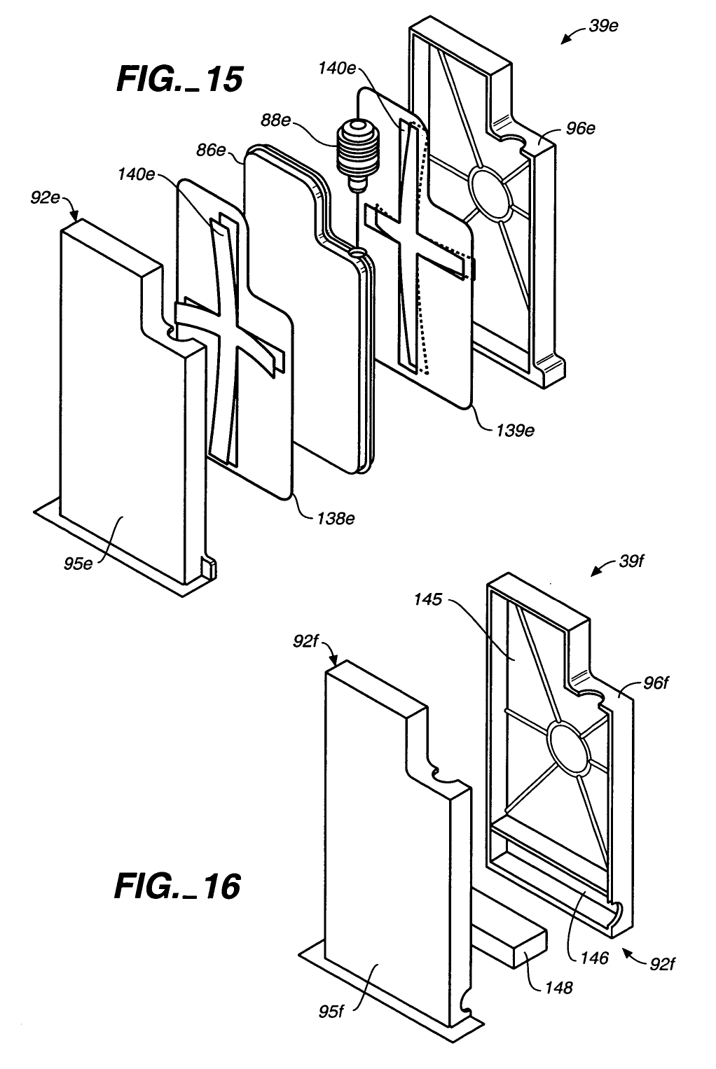

In another embodiment of the present invention shown in FIG. 15, removable fuel cartridge 39e is similar to the removable fuel cartridges described above but includes two spring plates 138e and 139e instead of foam pressure members. Like reference numerals have been used to describe like components of removable fuel cartridge 39e and those described above.

As shown in FIG. 15, removable fuel cartridge 39e generally includes an expandable fuel bladder 86e, a pair of spring plates 138e and 139e, and a sealable exit port 88e. In this embodiment, leaf spring members 140e are integral with spring plates 138e and 139e. Preferably, the spring plates are formed of steel, however, one will appreciate that the spring plates may be formed of other suitable materials which have an inherent memory. In the illustrated embodiment, each spring plate is provided with four leaf spring members thus providing a configuration which is capable of applying higher delivery pressures to the fuel bladder. Additionally, the multiple leaf spring configuration may provide a more uniform pressure throughout dispensing of fuel from the fuel bladder. One should appreciate that one, two, three, four or more leaf springs may be utilized in accordance with the present invention.

Removable fuel cartridge 39e includes a rigid container 92e formed of polycarbonate and/or other suitable material. Container 92e includes two container portions 95e and 96e which are permanently affixed to one another by a permanent adhesive, welding, and/or other suitable means such that the container permanently encloses expandable fuel bladder 86e and the expandable pressure members 87e.

The permanently affixed configuration of the container portions promotes the overall safety of fuel cartridge, as well as the safety of the fuel cell assembly and the portable electronic device with which it is used, because the configuration prohibits inadvertent or intentional tampering with the fuel bladder and the fuel contained therein. Thus, the permanently sealed configuration of the container portions also prohibits misuse of the fuel cartridge by accessing and misusing the fuel contained within.

In another embodiment of the present invention shown in FIG. 16, removable fuel cartridge 39f is similar to the removable fuel cartridges described above but incorporates an air filter and/or an ion exchange column (IEC) within the fuel cartridge. Like reference numerals have been used to describe like components of removable fuel cartridge 39f and those described above.

Although not shown in FIG. 16, removable fuel cartridge 39f generally includes an expandable fuel bladder, a pressure member and an exit port similar to those described above. In this embodiment, removable fuel cartridge 39f includes a rigid container 92f formed of polycarbonate and/or other suitable material. Container 92f includes two container portions 95f and 96f which define a primary chamber 145 for receiving and housing the expandable bladder and the pressure member in the same manner described above. Container portions 95f and 96f also define a supplemental chamber 146 that is dimensioned and configured to receive a supplemental component such as, but not limited to an air filters, fuel filters, ion exchange columns, fans, pumps, pump control chips, metering valves, metering pumps, membranes, water absorbents, carbon dioxide absorbents, and/or methanol absorbents, as generally indicated by the numeral 148. For example, an air filter may be provided for cleaning the air steam while an IEC may be provided for cleaning the methanol consumed by the fuel cell. Such supplemental components, for example, the filters, fans, pumps, ion exchange columns, etc., may be serviceable items which generally require replacement from time to time. By incorporating such supplemental components into the fuel cartridge, the serviceable supplemental component is automatically replaced each time a new fuel cartridge is installed into a portable electronic device such as a cell phone.

Container portions 95f and 96f are permanently affixed to one another by a permanent adhesive, welding, and/or other suitable means such that the container permanently encloses expandable fuel bladder 86f and the expandable pressure members 87f, as well as supplemental component 148.

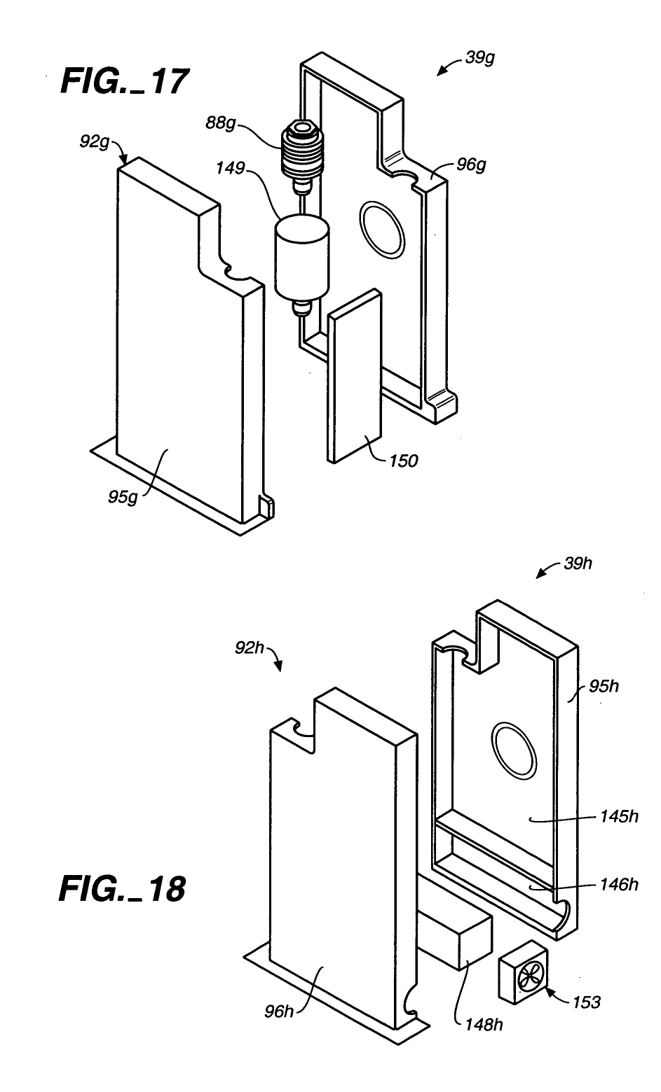

In another embodiment of the present invention shown in FIG. 17, removable fuel cartridge 39g is similar to the removable fuel cartridges described above but incorporates a pump 149 and/or a pump control chip 150 within the fuel cartridge. Like reference numerals have been used to describe like components of removable fuel cartridge 39g and those described above.

Although not shown in FIG. 17, removable fuel cartridge 39g generally includes an expandable fuel bladder and an exit port similar to those described above. In this embodiment, removable fuel cartridge 39g includes a rigid container 92g formed of polycarbonate and/or other suitable material. Container 92g includes two container portions 95g and 96g and houses the expandable bladder in the same manner described above.

Pump 149 may or may not be integrated with exit port 88g. Pump 149 may also be configured to supplement the force that is applied to the bladder by the expandable pressure members and/or the spring plates. Alternatively, pump 149 may be used instead of the expandable pressure members and/or the spring plates. For example, a positive displacement pump may be utilized to transfer the fuel within the bladder to the fuel cell in a controlled manner. Various pumps may be used in accordance with the present invention including, but not limited to, piezo-ceramic micro pumps of the type produced by Star Micronics America of Edison, N.J.

Pump 149 is of the type that is designed to minimize size and dimension. The reliability and operational lifespan of such pumps are often sacrificed in favor of a compact design. As such pumps may have a operation life on the order of one or two hundred hours, the pump may be deemed a serviceable item. Pump control chip 150 may be configured to store date regarding use of the pump whereby the chip may be utilized to determine the amount of fuel expended and/or the amount of fuel remaining within the fuel bladder (e.g., a fuel gauge). The size and shape of pump control chip 150 may be minimized at the expense of lifespan and or reliability of the control chip and, thus, may also be considered a serviceable item in a manner similar to the supplemental components discussed above. By incorporating such serviceable items into the fuel cartridge, the serviceable items are automatically replaced, in the same manner as supplemental component 148 discussed above, each time a new fuel cartridge is installed.

Container portions 95g and 96g are permanently affixed to one another by a permanent adhesive, welding, and/or other suitable means such that the container permanently encloses expandable fuel bladder 86g and the expandable pressure members 87g, as well as pump 149 and/or pump control chip 150.

In another embodiment of the present invention shown in FIG. 18, removable fuel cartridge 39h is similar to the removable fuel cartridges described above but incorporates an air filter and/or an ion exchange column (IEC) within the fuel cartridge and a fan. Like reference numerals have been used to describe like components of removable fuel cartridge 39h and those described above.

Although not shown in FIG. 18, removable fuel cartridge 39h generally includes an expandable fuel bladder, a pressure member and an exit port similar to those described above. In this embodiment, removable fuel cartridge 39h includes a rigid container 92h formed of polycarbonate and/or other suitable material. Container 92h includes two container portions 95h and 96h which include a primary chamber 145h for receiving and housing the expandable bladder and the pressure member in the same manner described above. Container portions 95h and 96h also define a supplemental chamber 146g that is dimensioned and configured to receive a supplemental component 148g and/or a fan 153 or other suitable blower means. Fan 153 is of the type which is designed to minimize size and dimension. The reliability and operational lifespan of such pumps are often sacrificed in favor of a compact design and may also be deemed a serviceable item. By incorporating the serviceable items, for example, the filter and/or the fan into the fuel cartridge, the serviceable items are automatically replaced each time a new fuel cartridge is installed.

Container portions 95h and 96h are permanently affixed to one another by a permanent adhesive, welding, and/or other suitable means such that the container permanently encloses expandable fuel bladder 86h and the expandable pressure members 87h, as well as supplemental component 148h and fan 153.

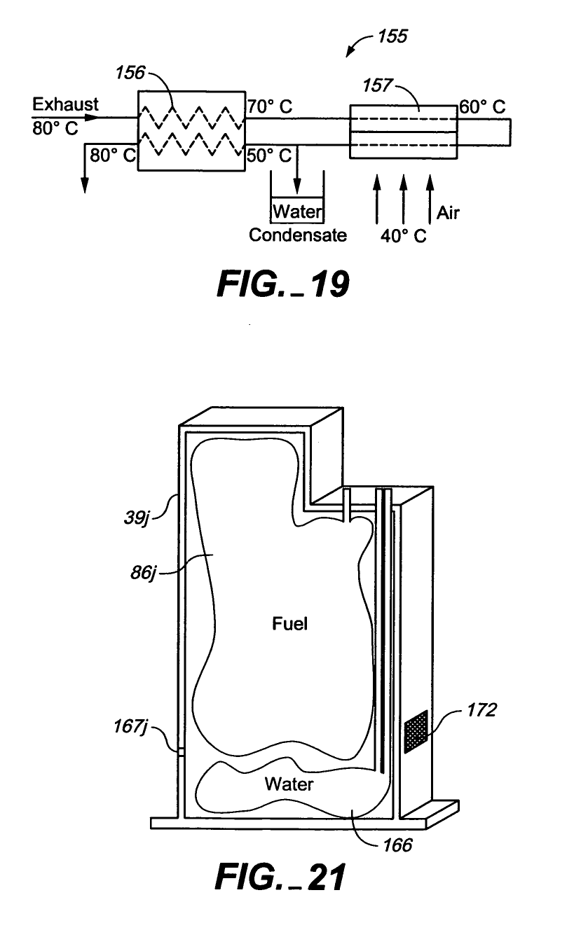

The fuel cell assembly of the present invention may be configured to recover water from the cathode exhaust stream, which recovered water may be used to replenish the anode side of polymer electrolyte membrane 53. In one embodiment, the fuel cell assembly or the removable fuel cartridge includes a water-recovery system 155 or part of such system such as that illustrated in FIG. 19 which includes a two-pass heat exchanger 156 and a condenser/radiator heat exchanger 157 fluidly connected in series such that the cathode exhaust feeds the recovery loop and a portion of the exhaust water is returned to replenish the anode. In this embodiment, condenser/radiator heat exchanger 157 includes a condenser and a radiator that are arranged back-to-back in such a manner to allow cross-flow of the exhaust water with cooling air. In the illustrated embodiment, 40° C. air may be used to cool the exhaust water approximately 20° C. as it passes through heat exchanger, however, one will appreciate that the actual temperatures and amount of cooling will depend upon the particular fuel cell assembly. As shown in FIG. 19, a portion of exhaust water exiting from condenser/radiator heat exchanger 157 at a lower temperature passes through two-pass heat exchanger 156 and thus adjusts the temperature of the recovered water before it arrives at the anode side of membrane electrode assembly 33. One will appreciate that the configuration of system 155 may vary depending upon various factors including the temperature of the exhaust water and the desired temperature of the recovered water.

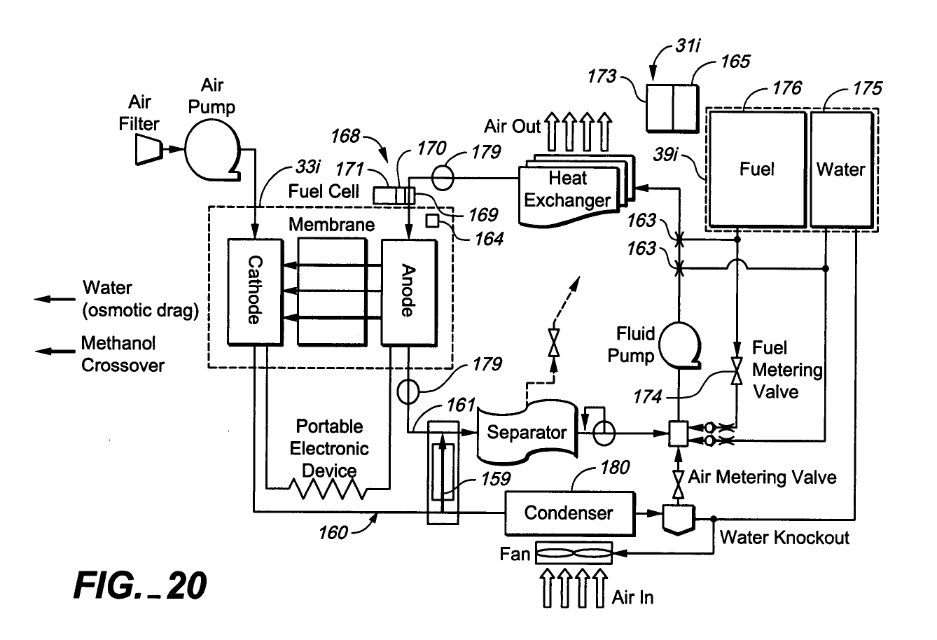

In one embodiment, fuel cell assembly 31i of the present invention may utilize a liquid/gas separator 158 in order to separate liquids from gases in the cathode and/or anode exhaust stream, as shown in FIG. 20. For example, a cyclone separator, a centrifugal separator, and/or other suitable means may be utilized to separate methanol, water and/or other liquids from gases.

As also shown in FIG. 20, fuel cell assembly 31i may include a separation membrane 159 between the cathode exhaust 160 and the anode loop 161 in order to keep the anode liquid and the cathode exhaust separate, to transfer heat from the cathode exhaust to the anode liquid, and/or to transfer water from the cathode exhaust to the anode loop due to the difference in concentration on each side of the membrane. One will appreciate that the separation membrane may include an osmosis membrane and/or other suitable means.

In one embodiment, the fuel cell assembly of the present invention may utilize a pressure differential between the water recovered from the cathode and the anode loops. The positive pressure differential between the cathode water supply and the anode loop may be created using a pump 149. The water injection point 162 of the anode loop may be located at the inlet to the anode pump which is the point of lowest pressure in the anode loop. An extractor 163 in the anode loop may also be used to create a local pressure point accelerating the fluid from the methanol source and/or the water source to lower the pressure. A negative pressure may also be applied to the anode loop to control the rate of fluid replacement. The negative pressure could also provide a driving force for methanol injection from a bladder contained in a vented cartridge such as that shown in FIG. 7.

One will appreciate that various approaches relating to methanol-water mixing may be utilized on accordance with the present invention including, but not limited to: the use of a reference cell 164 (see FIG. 20) in the fuel cell to control the concentration of methanol in the anode loop; the use of proportional injection whether passive or active as controlled by microprocessor control system (e.g., pump control chip 150, FIG. 17); the use of eductors where each eductor is sized to maintain a fixed flow rate for water and methanol (e.g., eductors 163); and the use of a look-up table 165 wherein a number of parameters are measured and a drop in performance is assumed to be due to a lowering of the concentration of methanol in the anode fluid.

One will also appreciate that various approaches for water removal may be utilized in accordance with the present invention. For example, evaporation may be used in which exhaust water is evaporated into air having a temperature higher than ambient air due to transfer of heat from the fuel cell system. In this embodiment, the cathode product water would be dripped, sprayed or wicked onto a high surface area with a high permeability matrix. Alternatively, condensation may be utilized. Product water may be condensed whereby the resultant cathode exhaust is saturated with water at a reduced temperature and then either reheated and released into the ambient atmosphere or vented into the cooling airflow. Another alternative is to sequester the water into the spent fuel cartridge. This would utilize the void capacity fuel cartridge generated as fuel is used. In this approach, a first flexible bladder 86j would contain methanol and a second flexible bladder or supplemental 166 within fuel cartridge 39j would receive excess cathode water, as shown schematically in FIG. 21. Such a fuel cartridge would preferably be vented to the atmosphere (e.g., via vent 167).

In addition to the foregoing, a product water or exhaust water formed at the cathode could diffuse back through polymer electrolyte membrane (e.g., PEM 53i, FIG. 20) to replenish water consumed at the anode. This would require the control of the temperature as well as the permeability and thickness of the polymer electrolyte membrane.

In the embodiment of FIG. 20 also illustrates an optional fuel sensor. Fuel cell assembly 31i may be provided with a fuel sensor 168 to monitor the concentration fuel in the anode fuel loop. In one embodiment, fuel sensor 168 is a methanol sensor that includes a sensor membrane 169 that is partially permeable to methanol and which is positioned to be in contact with the anode fuel-loop. Methanol crosses sensor membrane 169 to a catalyst layer 170 to which a thermocouple 171 is attached. One will appreciate that other means may be used to determine temperature including, but not limited to, infrared detectors, thermistors, and other suitable means. The temperature at thermocouple 171 is measured and compared to a reference temperature. The change in temperature is dependant upon the heat produced by the reaction of methanol at catalyst layer 170 which is proportional to the concentration of methanol in the anode fuel loop.

Sensor membrane 169 preferably includes a small amount of a suitable catalyst in contact with a methanol permeable membrane. For example, PtRu black and/or other suitable catalyst may be deposited on NAFION or other suitable membranes. The fuel sensor is configured such that air is readily provided to catalyst later 170 and allowing the egress of carbon dioxide and water away from the sensor catalyst layer 170. When the front surface of the sensor membrane is in contact with a solution of methanol, in this case, the fuel, an amount of methanol proportional to the methanol concentration of the fuel solution permeates through the sensor membrane and reacts with the catalyst in the presence of air in accordance with the following equation:

CH₃OH+3/2O₂→CO₂+2H₂O+heat Eq. (1)

The methanol/catalyst reaction produces heat which is measured as a temperature rise at the thermocouple, which thermocouple 171 is placed in intimate contact with the catalyst layer 170. In one embodiment, the sensor membrane has been demonstrated to respond to methanol concentrations in the range of 0.5 to 3 molar, reaching stable differential temperature readings on the order of two minutes.

One will appreciate that the sensor catalyst may be disposed in various configurations. For example, the sensor catalyst may be coated on the back side of the permeable sensor membrane, exist as a small amount of free floating powder, and/or be coated on a separate substrate and placed behind the sensor membrane. The method of delivering the methanol to the catalyst could be any method that delivers vapor, liquid methanol or methanol solution provided that the delivered amount is proportional to the concentration in the anode fuel loop. For example, a small portion of the fuel may be wicked or pumped to the sensor area. The fuel sensor may be placed in the wall of a reservoir or as a side arm attachment to the fuel flow loop.

In one embodiment, the fuel sensor is configured to measure a reference temperature and measure the temperature difference between the sensor temperature and the reference temperature in order to accommodate for the fact that a fuel cell generally does not operate at a single absolute temperature. For example, the reference temperature could be the temperature of the fuel near the membrane.

Since the permeation rate of methanol through ionically conducting membranes is know to also be temperature dependent, the fuel cell would ideally be operated at a constant reference temperature or, less ideally, its response could be calibrated over the expected range of operating temperature.

Operation of the fuel sensor immediately adjacent to the methanol solution, as compared to being located in the headspace of a reservoir, may facilitate a fully hydrated condition for the membrane. Such a fully hydrated condition is desirable because the methanol permeation characteristic of a given membrane is generally sensitive to the level of hydration of the membrane.

One will appreciate that the fuel sensor of the present invention is not limited to methanol fuel nor limited to fuel cells. For example, the concentration of any chemical that can permeate through a membrane and be readily oxidized on the surface of a catalyst with evolution of heat may be measured in the above-described manner.

In one embodiment, the fuel cell assembly is configured to indirectly identify the initial fuel concentration within a fuel cell cartridge. The U.S. Department of Transportation has issued a rule that a fuel container containing less than an initial 24% methanol concentration can be used in air transport, for example, on commercial airliners to power electronic devices. In other applications, cartridges containing higher initial methanol concentrations can be used.

In order to indirectly identify fuel concentration, removable fuel cartridge 39 is configured such that the concentration of methanol fuel within the fuel cartridge may be automatically determined by the fuel-cell assembly 33. In this embodiment, suitable identifying means 172 are used to identify the fuel cartridge, which means are easily readable by the fuel-cell assembly. Such an identifying means may or may not be incorporated into the host power consuming appliance such as portable electronic device 32.

In one embodiment shown in FIG. 21, removable fuel cartridge 39 includes optical markings 172 similar to those which identify the ASA rating of a 35 mm film cartridge thereby allowing the fuel cell assembly to determine which fuel concentration is present in removable fuel cartridge 39 by reading such markings optically when the fuel cartridge is loaded into the portable electronic device or the fuel cell assembly. It another embodiment, features may be provided on the fuel cartridge housing which may be read either mechanically (e.g., with a mechanical switch), electronically (e.g., by hall-effect, an integrated circuit chip, or other electronic means) and/or by other suitable means.

The fuel identifying configuration of the present invention may be configured to enable the fuel cell assembly to determine the methanol concentration of a fuel container thus allowing the determination of various operating parameters including fuel gauge, run-time, size and concentration of the fuel container. The identifying information of the fuel cartridge may also include other information including lot, date of manufacture, expiration date, the manufacture and/or other desired information.

Advantageously, the identifying system of the present invention would allow a user of the portable electronic device to carry fuel cartridges containing an initial 24% methanol concentration for air travel and for use while on an airline, and for the user to also use fuel cartridges that contain higher concentration methanol fuel for use at other times. The ability to use high-concentration methanol fuel cartridges increases the run-time of the appliance which is being powered by the direct methanol power generator employing the fuel cartridge. The ability to carry multiple air-travel-approved cartridges (i.e., less than 24% concentration) allows the user to operate the portable electronic device for extended periods through the use of multiple cartridges.

The identifying configuration of the present invention allows the standardization of replaceable fuel cartridges that may be used in a variety of fuel cell applications including, but not limited to portable electronic devices utilizing direct-methanol fuel-cell power generators. Generally, known fuel cell assemblies are limited in that the concentration of methanol which may be exposed to conventional polymer electrolyte membranes such as NAFION membranes produced by DuPont. At high concentrations, the polymer electrolyte membrane and the corresponding fuel cell will suffer from degradation effects which may reduce the performance and/or durability of the fuel cell power generator. Known fuel cell assemblies do not have suitable sensor technology for monitoring the methanol concentration within the fuel cell power generator. Thus, the identifying configuration of the present invention allows a fuel cell assembly to monitor the input concentration, that is, the initial fuel concentration of the replaceable fuel cartridge. A controller (e.g., controller 173, FIG. 20) of the fuel cell assembly may make suitable adjustments to control operating parameters of the fuel cell assembly in order to maintain suitable methanol concentration in the fuel cell assembly, thus reducing or eliminating the negative effects of improper fuel concentrations.

The identifying configuration of the present invention also allows for the technology progress of the fuel cell polymer electrolyte membrane without changing the design of the fuel cartridge. Advances are continually made in such membrane technology, which advances may allow the use of higher concentrations within the fuel cell itself. As such advances occur, it may be preferable to continue to use existing fuel cartridges in the future as such advances are brought forward into consumer products. The ability of the fuel concentration to be determined by the fuel cell power generator allows for the continued future use of the replaceable fuel cartridges of the present invention.

In accordance with the present invention, fuel feed from the fuel reservoir to the fuel-cell assembly may be accomplished in a variety of ways. In one embodiment, a fuel bladder may be pressurized, for example, by use of expandable pressure member 87 shown in FIG. 7 or other suitable means, and a metering valve 174 may be utilized to provide the required amount of fuel to the fuel-cell assembly. One will appreciate that a metering pump may be utilized instead of or in addition to the metering valve. Alternatively, a non-pressurized bladder may be used in combination with a positive displacement pump such as pump 149 shown in FIG. 17.

In one embodiment, the fuel-cell assembly is configured to accommodate freezability upon shutdown. During shut down, portions of the fuel cell assembly may experience substantial decreases in temperature approaching the freezing point of water. In the event that the fuel cell assembly includes a water source (i.e., water source 175 in FIG. 20), the fuel cell assembly may be configured to prevent freezing of water in the fuel loop by increasing the methanol concentration in the fuel loop above a predetermined level to prevent phase change of the fuel/water mixture in the fuel loop. For example the controller may actuate a metering valve, pump or other suitable means to increase methanol concentration in the fuel loop to above approximately 8 molar to prevent such phase change. Alternatively, the pump may be activated to substantially remove liquid water and/or other fluids from the fuel loop.

In one embodiment, the fuel cell assembly may be configured to circulate the fuel loop through a reservoir of pure methanol, as shown in FIG. 22. Anode loop 161 is in fluid communication with a fuel reservoir 176 containing methanol, preferably 100% methanol. A methanol diffusion membrane 177 is positioned between the entrance and exit ports to the methanol fuel reservoir 176 where each port contains a shut-off valve. The diffusion membrane is configured to allow the passage of methanol into the anode loop but prevent the diffusion of water into the fuel reservoir. A by-pass loop 178 is also provided which allows for the flow of anode fluid when the methanol container is excluded from the anode loop. During shut-down, the entry and exit ports to the methanol container are opened to allow the diffusion of methanol into the anode loop to an appropriate level to prevent freezing.

In one embodiment, the fuel cell assembly is provided with a temperature sensor (see, e.g., thermocouple 171, FIG. 20) and the fuel cell assembly is configured to prevent startup when the fuel cell assembly is below a certain temperature. For example, the fuel cell assembly may be configured to prevent startup if the temperature is below 32° F. in order to prevent damage to the assembly in the event that water is frozen within the assembly. Preferably, the fuel circuit valves are physically located adjacent entrance and exit passageways to membrane electrode assembly 33i (see, e.g., preferred locations 179, FIG. 20) in order to prevent excess fuel fluid from diffusing through the assembly (e.g., polymer electrolyte membrane 53i).

In one embodiment shown in FIG. 20, the fuel cell cartridge contains both fuel and a liquid water storage medium 176 and 175, respectively. In this embodiment, the cathode exhaust containing water is treated to liquefy water vapor. In this regard, a condenser 180 is provided to liquefy water vapor. Non-liquefied water vapor is then passed through a portion of the fuel cartridge for absorption or storage for replenishing water in the anode loop.

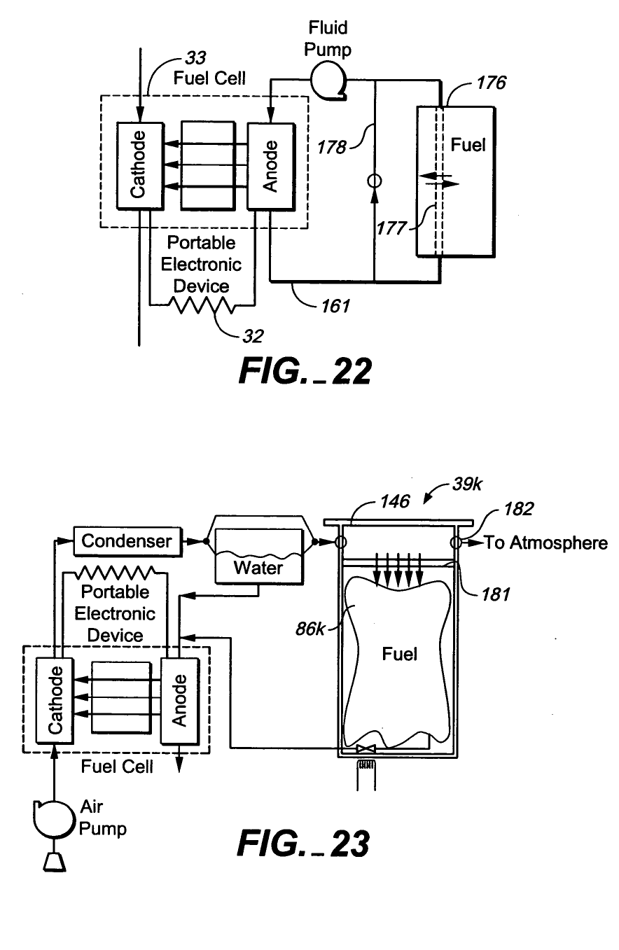

Waste carbon dioxide generated by the fuel cell assembly may be utilized in accordance with the present invention. For example, excess carbon dioxide may be fed to a fuel cartridge 39k container having a secondary chamber 146k defined in part by a movable piston wall 181 and having a relief valve 182 to hold pressure at approximately 1-2 psi so as to facilitate the flow of fuel from a flexible fuel bladder, as shown in FIG. 23. In particular, the pressure within the secondary chamber will remain at a relatively low pressure, which pressure will gently bias piston wall 181 against fuel bladder 86k. Thus, the waste carbon dioxide may be utilized to provide a positive pressure upon fuel bladder 86k within fuel cartridge 89k. One will appreciate that a supplemental bladder may replace the piston configuration in order to provide an expandable chamber fed by excess carbon dioxide which may provide a positive pressure against the fuel bladder. Alternatively, the waste carbon dioxide may be utilized to drive a reciprocating pump in order to generate power to improve fuel cell efficiency and/or alternatively to use other expansion devices such as a reciprocating solenoid or valve to fuel pump.

Other uses of the carbon dioxide exhaust include using it to vent to the cathode to oxidize methanol vapor contained in the CO₂ exhaust and venting CO₂ into the cathode chamber to eliminate oxygen and to prevent methanol combustion in the cathode chamber after shutdown.

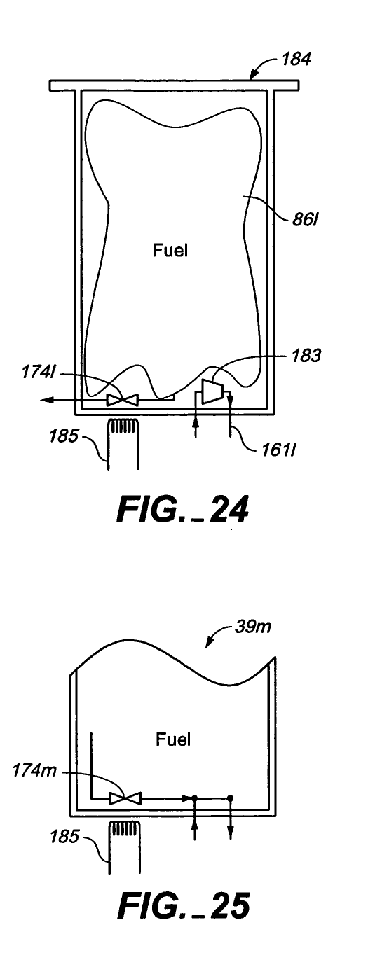

In another cartridge embodiment shown in FIG. 24, two ports are devoted to passing all or part of the anode loop 1611 through a fuel filter 183 contained within a disposable cartridge 184. One will appreciate that such a filter may have a limited useful lifespan and may need periodic replacement. Advantageously, placing the filter in a disposable fuel cartridge allows the fuel filter to automatically be replaced every time the disposable fuel cartridge is replaced. In one embodiment, the fuel filter is an organic filter, however, one will appreciate that any other suitable filter means may be used. Optionally, a third port of disposable cartridge 184 is in fluidic communication with the methanol within the fuel cartridge to provide methanol to the anode loop via a metering valve 1741 contained within the cartridge. The metering valve may be controlled by a system actuator 185 within the body of the fuel cell assembly or by an actuator located within the disposable fuel cartridge (not shown).

In an alternative embodiment shown in FIG. 25, only two ports are contained within the fuel cell cartridge. One port communicates with the fuel cell loop to allow the loop to flow into the fuel cartridge while the other port provides communication with the fuel loop to return the fuel flow. The fuel in the fuel cartridge is in fluid communication with the interior portion of the fuel cell loop within the cartridge. The flow of the fuel to the fuel cell loop is controlled by a metering valve 174 in the cartridge which is controlled by a system actuator 185 located in the body of the fuel cell and operably connected to the controller (e.g., controller 173).

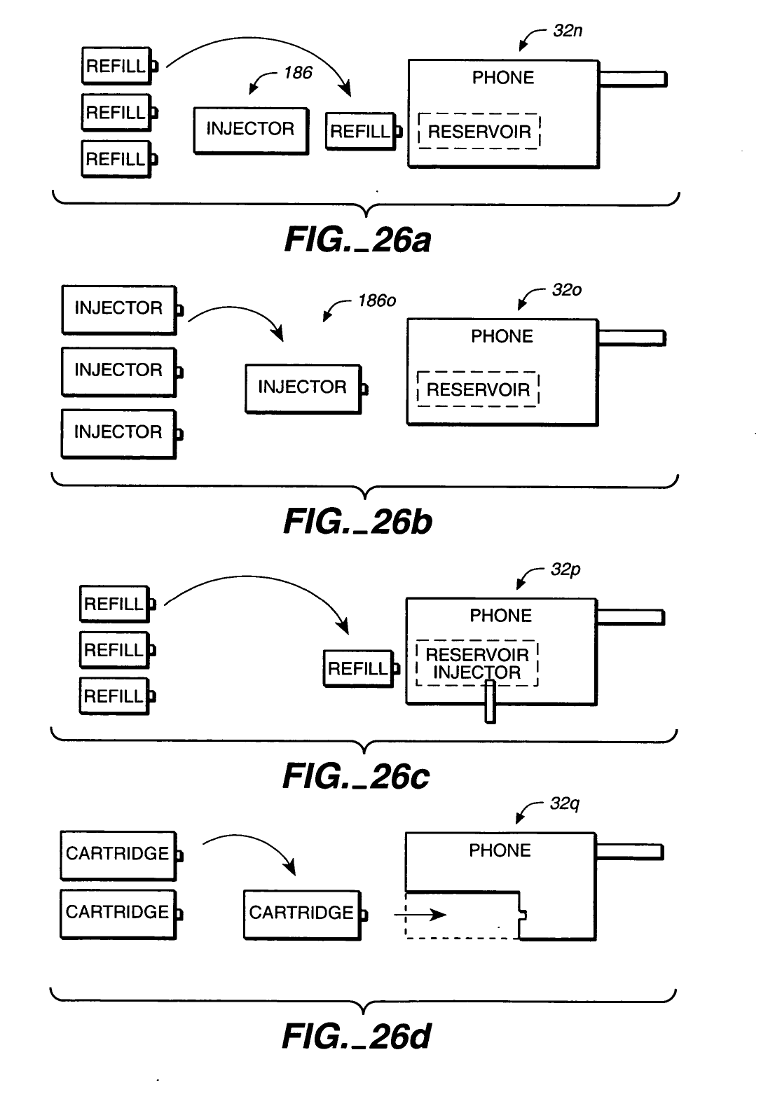

In other embodiments of the present invention, an injector assembly 186 having a fuel chamber 187 may be provided in combination with or instead of the replaceable fuel cartridge. The injector assembly may have various configurations including, but not limited to refillable injectors 188, disposable injectors 189, internal injectors 190 and disposable cartridges 191, as shown in FIG. 26(a) through FIG. 26(d), respectively. In the first three categories, the fuel reservoir is permanently within the portable electronic device. Injector assemblies of various forms are used to transfer fuel from a refill container into the reservoir located on the electronic device and/or the replaceable fuel cartridge. Alternatively, the injector can be located within the electronic device.

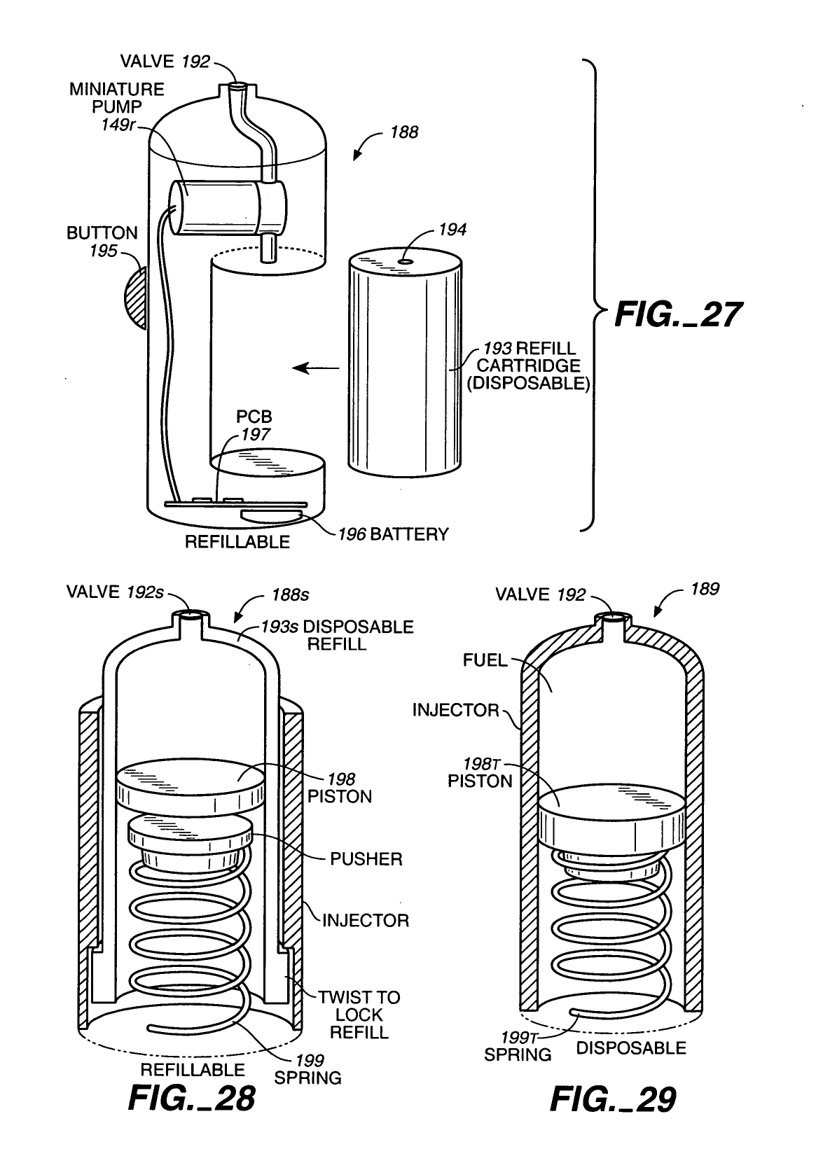

In one embodiment shown in FIG. 27, refillable injector 188 includes an injector valve 192 fluidly connected with an injector pump 149r and selectively coupled with a refill cartridge 193. The refill cartridge may be in the form of a plastic container, however, one will appreciate that other suitable containers and/or materials may be used. When the refill cartridge is inserted into refillable injector 188, a refill valve 194 opens thus allowing fuel for the fuel cell to be extracted from refill cartridge 193 by refillable injector 188. The injector pump, which may be activated by an injector control switch 195 that is located on an outside surface of the injector, is used to draw fluid from the refill cartridge and transfer it to the portable electronic device. In one embodiment, the injector pump is powered by an injector battery 196 and controlled by an injector-pump control board 197. The control board may be configured to detect when the fuel level of the portable electronic device is full and thereby deactivate the pump to prevent overfilling the portable electronic device with fuel. The control board may monitor fuel level by monitoring back-drive on the pump, by using a pressure sensor provided on the refillable injector, by a pressure sensor provided on the portable electronic device, and/or by other suitable means.

In another embodiment shown in FIG. 28, refillable injector 188s is a spring loaded injector assembly that includes a refill cartridge 193s sealed by cartridge valve 194s and an injector piston 198. The refill cartridge may be engagable with the refillable injector in a suitable manner. For example, the refill may be inserted into the refillable injector and twisted to lock the refill cartridge in the refillable injector. When refillable injector 188s is attached to a portable electronic device, the cartridge valve is automatically opened and fuel is allowed to transfer from refill cartridge 193s to the fuel cell assembly. An injector spring 199 may be used to bias the piston toward the refill valve and thus provide a positive pressure on the fuel to empty the fuel from the refill cartridge/refillable injector assembly. In another embodiment shown in FIG. 29, disposable injector 189 also includes an injector spring 199t and a piston 198t but does not include a discrete disposable refill cartridge and thus provide a simpler, albeit disposable configuration.

Advantageously, the design of the spring-loaded injectors is inexpensive and easy to manufacture. The refill cartridges may be mass produced in a manner similar to known insulin refill cartridges. Furthermore, the operation of such spring-loaded injectors is simple and allows fuel to be dispensed automatically upon insertion into a portable electronic device.

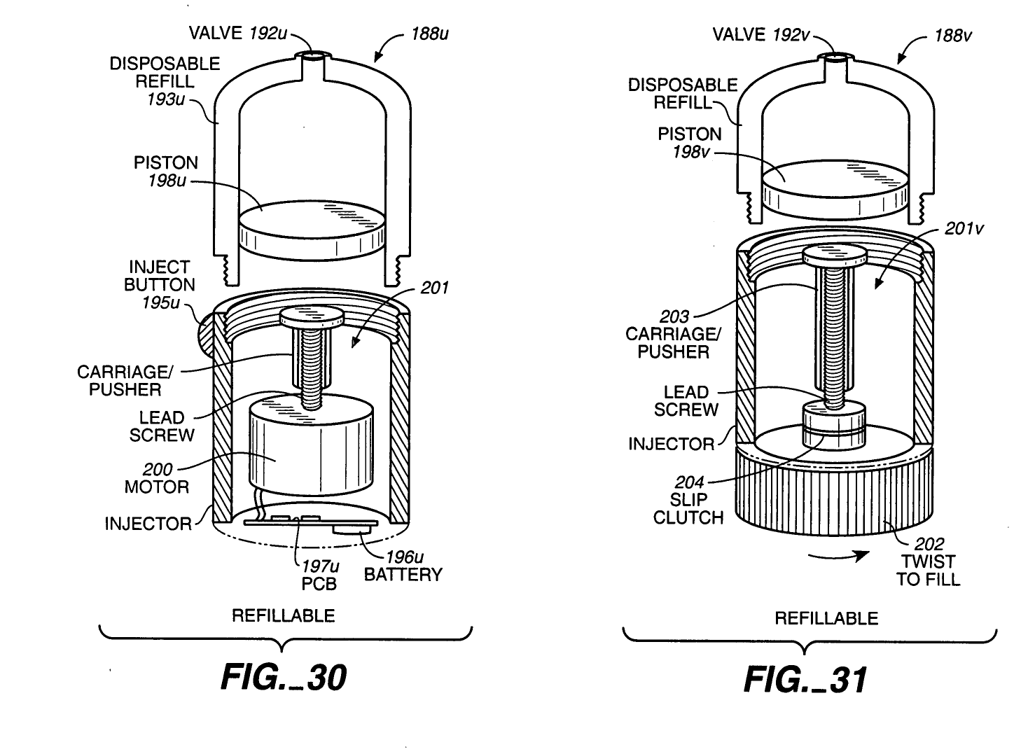

In another embodiment shown in FIG. 30, refillable injector 188u includes a disposable refill cartridge 193u that is also sealed by an injector valve 192u and an injector piston 198u. In this embodiment, the refill cartridge is threadably engaged with the injector assembly, however, one will appreciate that other engagement means may be used including, but not limited to, the twist-and-lock configuration discussed above. In this embodiment, when the refillable injector is attached to a portable electronic device, the injector valve automatically opened and fuel is allowed to transfer from the refill to the portable electronic device. An injector motor 200 and an injector drive 201 may be activated to bias the injector piston toward the injector valve and thus empty the contents of disposable refill 193u into the fuel cell assembly of the portable electronic device. In the illustrated embodiment, the injector drive is a lead screw assembly, however, one will appreciate that other suitable means may be utilized. By monitoring the back-drive of the injector motor, the refillable injector may detect when the fuel cell assembly is full and stop the refill process. Alternatively, a pressure sensor can be utilized in a manner similar to that described above to detect when the fuel cell assembly is fully fueled and stop the refill process.

In another embodiment shown in FIG. 31, refillable injector 188v includes a disposable refill cartridge similar to that described above but includes a manually-actuated injector drive assembly. In particular, injector drive 201v is activated by a hand-operated knob 202 such that lead screw 201v moves injector carriage 203 upwardly and thus biases injector piston 198v toward injector valve 192v to empty the contents of the refill cartridge into the portable electronic device. An injector slip clutch 204 may be provided to stop translation of the piston when the electronic device is fully fueled. The refill cartridge may be threadably engagable with the injector assembly as discussed above, however, one will appreciate that other suitable engagement means may also be used. One will also appreciate that the injector-drive configuration may also be utilized not only with refillable injector assemblies but also with disposable injector assemblies in accordance with the present invention.

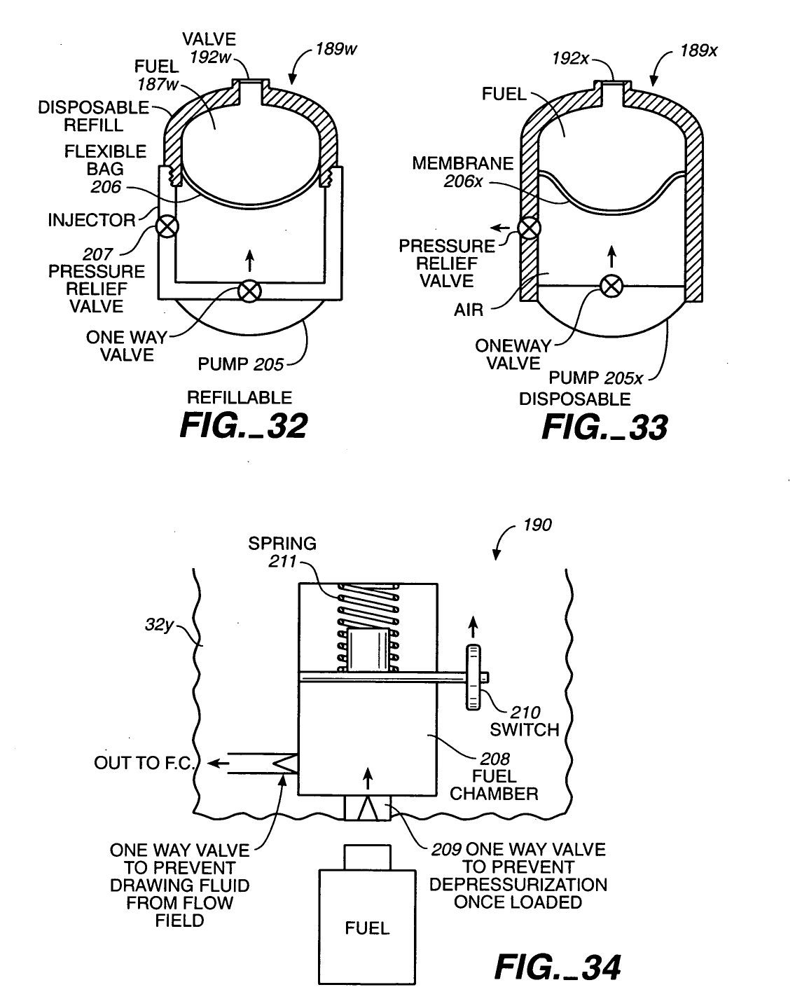

In another embodiment shown in FIG. 32, the injector assembly is similar to those discussed above but includes a manual pump assembly 205. For example, a refillable injector 188w or a disposable injector 189w may include a fuel chamber 187w that is sealed by injector valve 192w and a flexible membrane or diaphragm 206. In the illustrated embodiment, the manual pump assembly is a thumb actuated pump, similar to that found on REEBOK athletic shoes, and is configured to provide a positive pressure against the flexible diaphragm, which pressure may be utilized to transfer fuel from the injector assembly into portable electronic device. A pressure relief valve 207 may be provided to prevent a user from over-pressurizing the injector assembly and/or the portable electronic device. The pressure relief valve and/or other component of the injector assembly may also be configured to provide an audible indication of when the fill is complete. One will appreciate that the manual pump assembly may also be incorporated in a disposable injector assembly 189× as shown in FIG. 33.

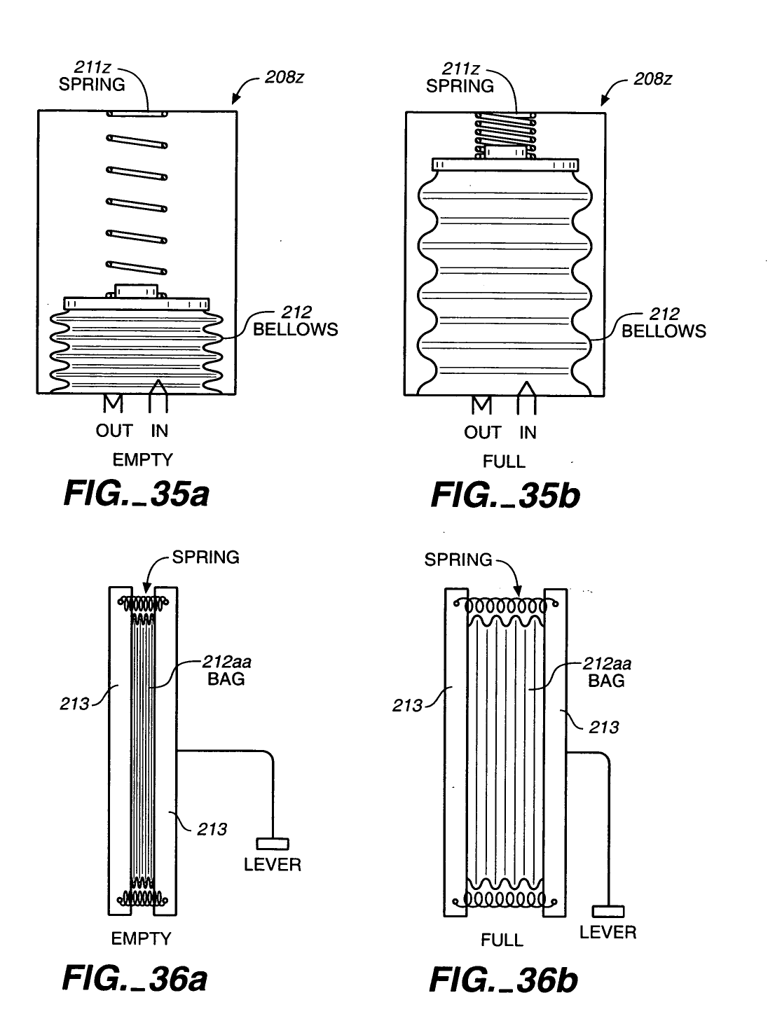

In another embodiment, an internal injector assembly 190 is provided that embodies all of the functionality of the refillable and disposable injector assemblies discussed above but is located within a portable electronic device, as shown in FIG. 34. Advantageously, such a configuration may contribute to a reduction in size, cost and complexity of the refill cartridge and may also prevent over-pressurization. In this embodiment, portable electronic device 32y includes a fuel reservoir 208 having a one-way filling valve 209 to allow refilling. Once refill cartridge 193 is engaged with the filling valve and in fluid communication with the fuel reservoir, a filling lever 210 may be depressed such that it enlarges the fuel chamber thereby creating a negative pressure therein that can be utilized to draw fuel from the refill cartridge. By depressing the lever, a fuel chamber spring 211 is compressed to provide a positive pressure capable of pumping the fuel from the fuel reservoir into the fuel circuit of the fuel cell assembly of portable electronic device once fueling is complete, that is, once fuel chamber 208 is substantially full. In this regard, one will appreciate that the fuel chamber spring functions in a similar manner as the expandable pressure member 87 discussed above. In another embodiment, fuel reservoir 208z may include a bladder in the form of a bellows 212 that may further enhance fuel retention within the fuel reservoir, as shown in FIG. 35. One will appreciate that the bellows may be used in combination with circular or rectangular pistons.

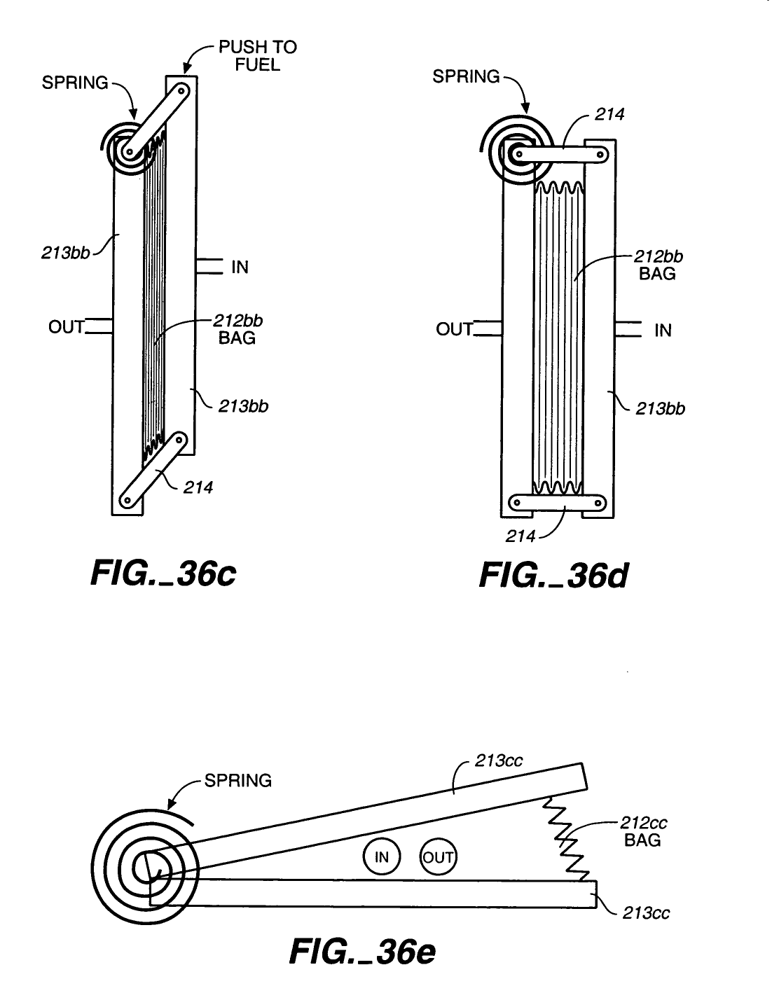

One will appreciate that other suitable bladder configurations may be utilized in accordance with the present invention. In one embodiment shown in FIG. 36(a), bladder 212aa may be used in combination with, and disposed between, two side compression plates 213 as shown in FIG. 36(a) which are spring biased toward one another to provide a positive pressure on the bladder in a manner similar to compression plates 138 and 139 discussed above. Alternatively, compression plates 213bb may be provided with interconnecting links 214 which biases the compression plates toward one another by a coil spring, as shown in FIG. 36(b). Further still, compression plates 213cc may be pivotally connected with a hinge in which the compression plates are biased toward one another by a coil spring, as shown in FIG. 36(c).

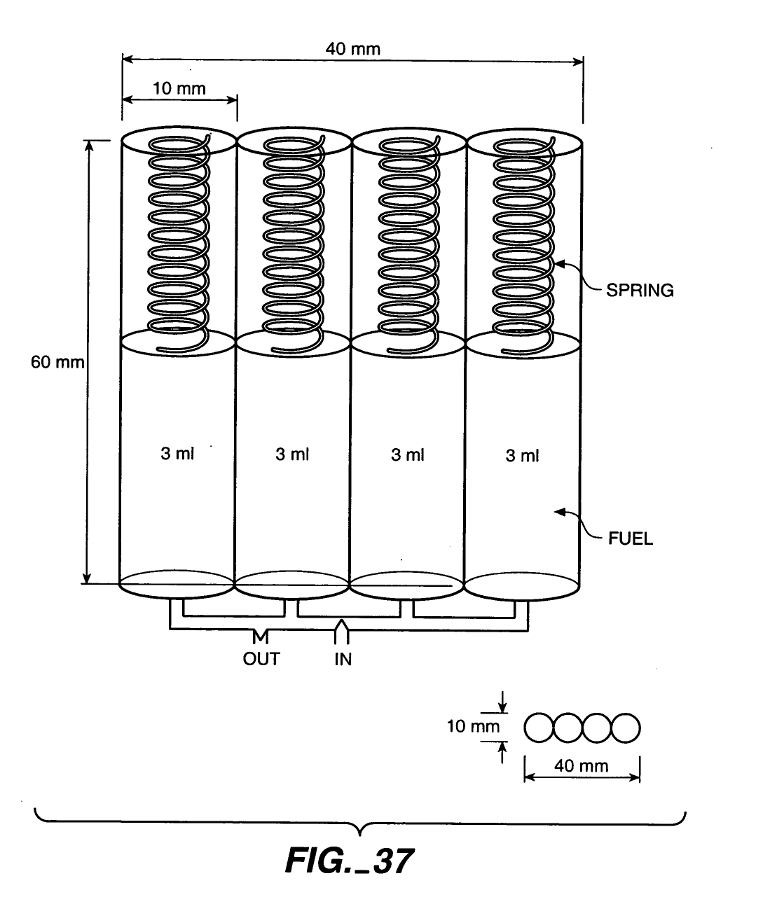

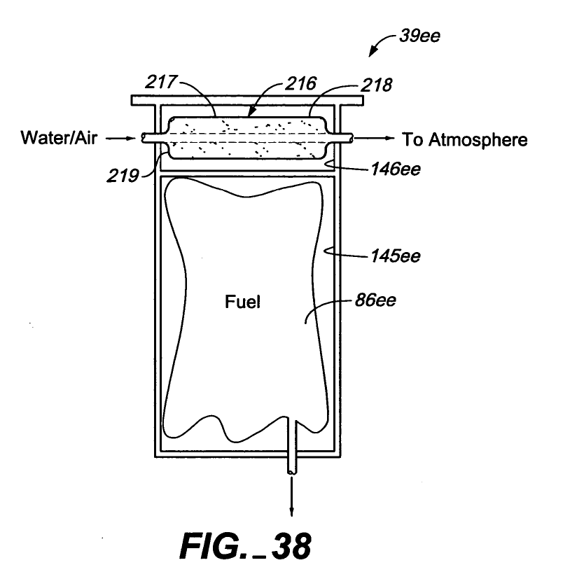

One will appreciate that one, two, three or more fuel injectors, refill cartridges and/or fuel reservoirs may be utilized in accordance with the present invention. For example, as shown in FIG. 37, a plurality of syringes 215 may be used to draw fluid from the injector assemblies and/or refill cartridges in a manner similar to that described above. Multiple syringes may be used in order to achieve increased volumes as may be required by larger portable electronic devices such as laptops and other appliances utilizing a fuel cell assembly.

In one embodiment, as shown in FIG. 38, removable fuel cartridge is provided with a primary chamber 145ee that houses an expandable fuel bladder 86ee which is in fluid communication with an inlet port on the anode side of a fuel cell assembly in a manner similar to that described above. In this embodiment, an absorbent device 216 is located in a secondary chamber 146ee. In one embodiment, device 216 is an annular tubular member including a latex tube 217 surrounding a porous material 218 and filled with a desiccant 219. The porous material may include a screen, a permeable membrane, and or other suitable means which allow the selective passage of water and/or other substance to be absorbed. In the event that water is the targeted substance to be absorbed, the desiccant may include acrylic acid, carrageenan and/or other materials suitable to absorb water. One will appreciate that other desiccants may be utilized to absorb other the targeted substances including, but not limited to, carbon dioxide and methane. One will also appreciate that irreversible absorbents or reversible absorbents may be utilized as the desiccant.

In the embodiment illustrated in FIG. 38, absorbent device 216 is fluidly connected with an exhaust port on the cathode side of the fuel cell chamber and configured to receive water and air exhaust from the cathode. In this embodiment, the absorbent device is configured to capture or absorb the water from the exhaust stream. Such a water-absorbing configuration is particularly useful to remove water from the exhaust stream when the exhaust air is utilized by the cathode, as such a water-absorbing configuration will increase the freezing tolerance of the fuel cell assembly as water will be removed from the fuel cell fluid circuit.

In many respects the modifications of the various figures resemble those of preceding modifications and the same reference numerals followed by subscripts “a” through “ee” designate corresponding parts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A removable fuel cell cartridge for a liquid fuel cell assembly comprising:
a container comprising a first chamber for fuel comprising at least one port for delivery of fuel to a fuel cell assembly; and
a second chamber for one or more supplemental components, wherein said second chamber comprises at least two ports at least one of which communicates with said fuel cell assembly.

2. The fuel cartridge of claim 1 wherein said first and said second chambers are separated by an immovable divider.

3. The fuel cartridge of claim 1 wherein said supplemental components are selected from the group consisting of air filters, fuel filters, an ion exchange column, a fan, a pump, a pump control chip, a metering valve, a metering pump, a membrane, a water absorbent, a carbon dioxide absorbent, and a methanol absorbent.

4. The fuel cartridge of claim 1 wherein said container has a proximal end which engages said fuel cell assembly and a distal end opposite said proximal end, wherein each of said first and second chambers is located between said proximal and said distal ends of said container.

5. The fuel cartridge of claim 1 wherein said container has a proximal end which engages said fuel cell assembly and a distal end opposite said proximal end, wherein said first chamber is located near said proximal end and said second chamber is located near said distal end.

6. The fuel cartridge of claim 1 wherein said container has a proximal end which engages said fuel cell assembly and a distal end opposite said proximal end wherein said second chamber is located near said proximal end and said first chamber is located near said distal end.

7. The fuel cartridge of claim 6 wherein said second chamber contains a metering valve or a metering pump in fluid communication with said first chamber by way of a first port and wherein said second chamber comprises a second port positioned to be in fluid communication with an anode loop of said fuel cell assembly.

8. The fuel cartridge of claim 7 wherein said fuel metering valve or metering pump is capable of being controlled by an actuator located within said fuel cell assembly.

9. The fuel cartridge of claim 6 wherein said second chamber comprises an inlet and outlet port for fluid communication with the anode loop of said fuel cell assembly, a fluidic connector between said inlet and outlet ports and a metering valve or a metering pump in fluid communication with said first chamber and said fluidic connector.

10. The fuel cartridge of claim 9 wherein said fuel metering valve or metering pump is capable of being controlled by an actuator located within said fuel cell assembly.

11. The fuel cartridge of claim 9 further comprising a fuel filter in said second chamber in fluid communication with said first chamber or said fluidic connector.

12. The fuel cartridge of claim 9 further comprising an ion exchange resin in fluid communication with said first chamber or said fluidic connector.

13. The fuel cartridge of claim 9 wherein said second chamber comprises an inlet and outlet port for fluid communication with the anode loop of said fuel cell assembly, a fluidic connector between said inlet and outlet ports and a metering valve or a metering in fluid communication with said first chamber and a fuel feed port for fluid communication with the anode loop in said fuel cell assembly.

14. A removable fuel cell cartridge for a liquid fuel cell assembly comprising
a container including a first chamber for fuel having at least one port for delivery of fuel to a fuel cell assembly; and
an absorbent device having at least two ports at least one of which communicates with said fuel cell assembly.

15. The fuel cell cartridge of claim 14 wherein said absorbent device is configured to remove water an exhaust loop from said fuel cell assembly.

16. The fuel cell cartridge of claim 14 wherein said container includes a second chamber and said absorbent device is located in said second chamber.

17. The fuel cell cartridge of claim 16 wherein said first and said second chambers are separated by an immovable divider.

18. The fuel cartridge of claim 14 further comprising one or more supplemental components selected from the group consisting of air filters, fuel filters, an ion exchange column, a fan, a pump, a pump control chip, a metering valve, a metering pump, a membrane, a water absorbent, a carbon dioxide absorbent, and a methanol absorbent.

19. A fuel cell assembly comprising the fuel cartridge of claim 1 or 14.

20. An electronic device comprising the fuel cell of claim 19.

21. An electrical power supply comprising the fuel cell of claim 19.

22. The power supply of claim 21 comprising a plurality of fuel cartridges.
